(19) United States
(12) Patent Application Publication
(10) Pub. No.: US 2024/0364414 A1
(43) Pub. Date: Oct. 31, 2024

(54) BEAMFORMING REPEATER WITH CONTROL CHANNEL

(71) Applicant: Nokia Technologies Oy, Espoo (FI)

(72) Inventors: Kevin WANUGA, Murray Hill, NJ (US); Anup TALUKDAR, Naperville, IL (US); Axel MUELLER, Massy (FR); Toni Harri Henrikki LAHTEENSUO, Espoo (FI); Eugene VISOTSKY, Naperville, IL (US); Mark CUDAK, Naperville, IL (US); Kenneth GUSTAFSON, Schaumburg, IL (US)

(21) Appl. No.: 18/566,375

(22) PCT Filed: Jun. 3, 2022
(86) PCT No.: PCT/IB2022/055217

§ 371 Date: Dec. 1, 2023

Related U.S. Application Data
(60) Provisional application No. 63/197,149, filed on Jun. 4, 2021.

(51) Int. Cl. H04B 7/155; H04B 7/06; H04B 7/08

(52) U.S. Cl. CPC H04B 7/15528; H04B 7/0695; H04B 7/088

(57) ABSTRACT

Systems, methods, apparatuses, and computer program products for beamforming repeater and/or for hybrid beamforming repeater may be provided. For example, adaptive beamforming capabilities for the access link of the repeaters and beamforming on a backhaul link to a donor node may be provided.

### CROSS-REFERENCE TO RELATED APPLICATION

This application claims priority from U.S. provisional patent application No. 63/197,149 filed on Jun. 4, 2021. The contents of this earlier filed application are hereby incorporated by reference in their entirety.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for beamforming repeater with control channel.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

Some example embodiments may be directed to a method. The method may include receiving, from a donor network node, at least one of transmit beam information for an access link transmit beam of a network element and corresponding activation time periods, and receive beam information for an access link receive beam of the network element and corresponding activation time periods. In certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The method may also include performing one or more of amplifying and transmitting one or more downlink signals and channels on the access link transmit beam of the network element, or amplifying and transmitting over a backhaul link one or more uplink signals and channels received from the access link receive beam of the network element.

Other example embodiments may be directed to an apparatus. The apparatus may include at least one processor and at least one memory including computer program code. The at least one memory and computer program code may also be configured to, with the at least one processor, cause the apparatus at least to receive, from a donor network node, at least one of transmit beam information for an access link transmit beam of a network element and corresponding activation time periods, and receive beam information for an access link receive beam of the network element and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The apparatus may also be caused to perform one or more of amplifying and transmitting one or more downlink signals and channels on the access link transmit beam of the network element, or amplifying and transmitting over a backhaul link one or more uplink signals and channels received from the access link receive beam of the network element.

Other example embodiments may be directed to an apparatus. The apparatus may include means for receiving, from a donor network node, at least one of transmit beam information for an access link transmit beam of a network element and corresponding activation time periods, and receive beam information for an access link receive beam of the network element and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The apparatus may also include means for performing one or more of amplifying and transmitting one or more downlink signals and channels on the access link transmit beam of the network element, or amplifying and transmitting over a backhaul link one or more uplink signals and channels received from the access link receive beam of the network element.

In accordance with other example embodiments, a non-transitory computer readable medium may be encoded with instructions that may, when executed in hardware, perform a method. The method may include receiving, from a donor network node, at least one of transmit beam information for an access link transmit beam of a network element and corresponding activation time periods, and receive beam information for an access link receive beam of the network element and corresponding activation time periods. In certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The method may also include performing one or more of amplifying and transmitting one or more downlink signals and channels on the access link transmit beam of the network element, or amplifying and transmitting over a backhaul link one or more uplink signals and channels received from the access link receive beam of the network element.

Other example embodiments may be directed to a computer program product that performs a method. The method may include receiving, from a donor network node, at least one of transmit beam information for an access link transmit beam of a network element and corresponding activation time periods, and receive beam information for an access link receive beam of the network element and corresponding activation time periods. In certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The method may also include performing one or more of amplifying and transmitting one or more downlink signals and channels on the access link transmit beam of the network element, or amplifying and transmitting over a backhaul link one or more uplink signals and channels received from the access link receive beam of the network element.

Other example embodiments may be directed to an apparatus that may include circuitry configured to receive, from a donor network node, at least one of transmit beam information for an access link transmit beam of a network element and corresponding activation time periods, and receive beam information for an access link receive beam of the network element and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The apparatus may also include circuitry configured to perform one or more of amplifying and transmitting one or more downlink signals and channels on the access link transmit beam of the network element, or amplifying and transmitting over a backhaul link one or more uplink signals and channels received from the access link receive beam of the network element.

Certain example embodiments may be directed to a method. The method may include transmitting at least one of transmit beam information for an access link transmit beam of a repeater and corresponding activation time periods, and receive beam information for an access link receive beam of the repeater and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The method may also include performing one or more of transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

Other example embodiments may be directed to an apparatus. The apparatus may include at least one processor and at least one memory including computer program code. The at least one memory and computer program code may be configured to, with the at least one processor, cause the apparatus at least to transmit at least one of transmit beam information for an access link transmit beam of a repeater and corresponding activation time periods, and receive beam information for an access link receive beam of the repeater and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The apparatus may also be caused to perform one or more of transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

Other example embodiments may be directed to an apparatus. The apparatus may include means for transmitting at least one of transmit beam information for an access link transmit beam of a repeater and corresponding activation time periods, and receive beam information for an access link receive beam of the repeater and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The apparatus may also include means for performing one or more of transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

In accordance with other example embodiments, a non-transitory computer readable medium may be encoded with instructions that may, when executed in hardware, perform a method. The method may include transmitting at least one of transmit beam information for an access link transmit beam of a repeater and corresponding activation time periods, and receive beam information for an access link receive beam of the repeater and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The method may also include performing one or more of transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

Other example embodiments may be directed to a computer program product that performs a method. The method may include transmitting at least one of transmit beam information for an access link transmit beam of a repeater and corresponding activation time periods, and receive beam information for an access link receive beam of the repeater and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The method may also include performing one or more of transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

Other example embodiments may be directed to an apparatus that may include circuitry configured to transmit at least one of transmit beam information for an access link transmit beam of a repeater and corresponding activation time periods, and receive beam information for an access link receive beam of the repeater and corresponding activation time periods. According to certain example embodiments, there is a mapping between transmission of a downlink channel and signal over backhaul downlink beam and transmission over the access link transmit beam, and between receiving over the access link receive beam and receiving of an uplink channel and signal over backhaul uplink beam. The apparatus may also include circuitry configured to perform one or more of transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

Some example embodiments may be directed to a method. The method may include receiving, from a donor network node, at least one of a channel allocation and configuration for one or more of a synchronization signal block, a physical random access channel, a channel state information reference signal, a sounding reference signal, a system information block, access link beam information, dynamic transmit beam information for an access link transmit beam of network element and corresponding activation time periods, and dynamic receive beam information for an access link receive beam of the network element and corresponding activation periods. The method may also include performing one or more of transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

Other example embodiments may be directed to an apparatus. The apparatus may include at least one processor and at least one memory including computer program code. The at least one memory and computer program code may also be configured to, with the at least one processor, cause the apparatus at least to receive, from a donor network node, at least one of a channel allocation and configuration for one or more of a synchronization signal block, a physical random access channel, a channel state information reference signal, a sounding reference signal, a system information block, access link beam information, dynamic transmit beam information for an access link transmit beam of network element and corresponding activation time periods, and dynamic receive beam information for an access link receive beam of the network element and corresponding activation periods. The apparatus may also be caused to perform one or more of transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

Other example embodiments may be directed to an apparatus. The apparatus may include means for receiving, from a donor network node, at least one of a channel allocation and configuration for one or more of a synchronization signal block, a physical random access channel, a channel state information reference signal, a sounding reference signal, a system information block, access link beam information, dynamic transmit beam information for an access link transmit beam of network element and corresponding activation time periods, and dynamic receive beam information for an access link receive beam of the network element and corresponding activation periods. The apparatus may also include means for performing one or more of transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

In accordance with other example embodiments, a non-transitory computer readable medium may be encoded with instructions that may, when executed in hardware, perform a method. The method may include receiving, from a donor network node, at least one of a channel allocation and configuration for one or more of a synchronization signal block, a physical random access channel, a channel state information reference signal, a sounding reference signal, a system information block, access link beam information, dynamic transmit beam information for an access link transmit beam of network element and corresponding activation time periods, and dynamic receive beam information for an access link receive beam of the network element and corresponding activation periods. The method may also include performing one or more of transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

Other example embodiments may be directed to a computer program product that performs a method. The method may include receiving, from a donor network node, at least one of a channel allocation and configuration for one or more of a synchronization signal block, a physical random access channel, a channel state information reference signal, a sounding reference signal, a system information block, access link beam information, dynamic transmit beam information for an access link transmit beam of network element and corresponding activation time periods, and dynamic receive beam information for an access link receive beam of the network element and corresponding activation periods. The method may also include performing one or more of transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

Other example embodiments may be directed to an apparatus that may include circuitry configured to receive, from a donor network node, at least one of a channel allocation and configuration for one or more of a synchronization signal block, a physical random access channel, a channel state information reference signal, a sounding reference signal, a system information block, access link beam information, dynamic transmit beam information for an access link transmit beam of network element and corresponding activation time periods, and dynamic receive beam information for an access link receive beam of the network element and corresponding activation periods. The apparatus may also include circuitry configured to perform one or more of transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

Some example embodiments may be directed to a method. The method may include transmitting at least one of a semi-static channel allocation and configuration for one or more of a synchronization signal block, a physical random access channel, a channel state information reference signal, a sounding reference signal, a system information block, access link beam information, dynamic transmit beam information for an access link transmit beam of a repeater and corresponding activation time periods, and dynamic receive beam information for an access link receive beam of the repeater and corresponding activation periods. The method may also include performing one or more of transmitting one or more downlink channels on a backhaul link transmit beam to be forwarded by the repeater on the access link transmit beam, or receiving one or more amplified uplink channels on the backhaul link receive beam that was received by the repeater from the access link receive beam. The method may further include using a scrambling code derived from a cell identifier of the repeater for transmission of the one or more downlink channels to one or more user equipment attached to the repeater, or for reception of the one or more uplink channels from the one or more user equipment.

Other example embodiments may be directed to an apparatus. The apparatus may include at least one processor and at least one memory including computer program code. The at least one memory and computer program code may also be configured to, with the at least one processor, cause the apparatus at least to transmit at least one of a semi-static channel allocation and configuration for one or more of a synchronization signal block, a physical random access channel, a channel state information reference signal, a sounding reference signal, a system information block, access link beam information, dynamic transmit beam information for an access link transmit beam of a repeater and corresponding activation time periods, and dynamic receive beam information for an access link receive beam of the repeater and corresponding activation periods. The apparatus may also be caused to perform one or more of transmitting one or more downlink channels on a backhaul link transmit beam to be forwarded by the repeater on the access link transmit beam, or receiving one or more amplified uplink channels on the backhaul link receive beam that was received by the repeater from the access link receive beam. The apparatus may further be caused to use a scrambling code derived from a cell identifier of the repeater for transmission of the one or more downlink channels to one or more user equipment attached to the repeater, or for reception of the one or more uplink channels from the one or more user equipment.

Other example embodiments may be directed to an apparatus. The apparatus may include means for transmitting at least one of a semi-static channel allocation and configuration for one or more of a synchronization signal block, a physical random access channel, a channel state information reference signal, a sounding reference signal, a system information block, access link beam information, dynamic transmit beam information for an access link transmit beam of a repeater and corresponding activation time periods, and dynamic receive beam information for an access link receive beam of the repeater and corresponding activation periods. The apparatus may also include means for performing one or more of transmitting one or more downlink channels on a backhaul link transmit beam to be forwarded by the repeater on the access link transmit beam, or receiving one or more amplified uplink channels on the backhaul link receive beam that was received by the repeater from the access link receive beam. The apparatus may further include means for using a scrambling code derived from a cell identifier of the repeater for transmission of the one or more downlink channels to one or more user equipment attached to the repeater, or for reception of the one or more uplink channels from the one or more user equipment.

In accordance with other example embodiments, a non-transitory computer readable medium may be encoded with instructions that may, when executed in hardware, perform a method. The method may include transmitting at least one of a semi-static channel allocation and configuration for one or more of a synchronization signal block, a physical random access channel, a channel state information reference signal, a sounding reference signal, a system information block, access link beam information, dynamic transmit beam information for an access link transmit beam of a repeater and corresponding activation time periods, and dynamic receive beam information for an access link receive beam of the repeater and corresponding activation periods. The method may also include performing one or more of transmitting one or more downlink channels on a backhaul link transmit beam to be forwarded by the repeater on the access link transmit beam, or receiving one or more amplified uplink channels on the backhaul link receive beam that was received by the repeater from the access link receive beam. The method may further include using a scrambling code derived from a cell identifier of the repeater for transmission of the one or more downlink channels to one or more user equipment attached to the repeater, or for reception of the one or more uplink channels from the one or more user equipment.

Other example embodiments may be directed to a computer program product that performs a method. The method may include transmitting at least one of a semi-static channel allocation and configuration for one or more of a synchronization signal block, a physical random access channel, a channel state information reference signal, a sounding reference signal, a system information block, access link beam information, dynamic transmit beam information for an access link transmit beam of a repeater and corresponding activation time periods, and dynamic receive beam information for an access link receive beam of the repeater and corresponding activation periods. The method may also include performing one or more of transmitting one or more downlink channels on a backhaul link transmit beam to be forwarded by the repeater on the access link transmit beam, or receiving one or more amplified uplink channels on the backhaul link receive beam that was received by the repeater from the access link receive beam. The method may further include using a scrambling code derived from a cell identifier of the repeater for transmission of the one or more downlink channels to one or more user equipment attached to the repeater, or for reception of the one or more uplink channels from the one or more user equipment.

Other example embodiments may be directed to an apparatus that may include circuitry configured to transmit at least one of a semi-static channel allocation and configuration for one or more of a synchronization signal block, a physical random access channel, a channel state information reference signal, a sounding reference signal, a system information block, access link beam information, dynamic transmit beam information for an access link transmit beam of a repeater and corresponding activation time periods, and dynamic receive beam information for an access link receive beam of the repeater and corresponding activation periods. The apparatus may also include circuitry configured to perform one or more of transmitting one or more downlink channels on a backhaul link transmit beam to be forwarded by the repeater on the access link transmit beam, or receiving one or more amplified uplink channels on the backhaul link receive beam that was received by the repeater from the access link receive beam. The apparatus may further include circuitry configured to use a scrambling code derived from a cell identifier of the repeater for transmission of the one or more downlink channels to one or more user equipment attached to the repeater, or for reception of the one or more uplink channels from the one or more user equipment.

### BRIEF DESCRIPTION OF THE DRAWINGS

For proper understanding of example embodiments, reference should be made to the accompanying drawings, wherein:

FIG. 1 illustrates an example architecture of a beamforming repeater with control channel, according to some embodiments;

FIG. 2 illustrates an example of synchronization signal block (SSB) allocations in the beamforming repeater of FIG. 1, according to some embodiments;

FIG. 3 illustrates an example signal diagram for SSB transmission by the beamforming repeater of FIG. 1, according to some embodiments;

FIG. 4 illustrates an example signal diagram for system information block (SIB) transmission by the beamforming repeater of FIG. 1, according to some embodiments;

FIG. 5 illustrates an example signal diagram for a random access procedure by the beamforming repeater of FIG. 1, according to some embodiments;

FIG. 6 illustrates an example signal diagram for downlink data transmission by the beamforming repeater of FIG. 1, according to some embodiments;

FIG. 7 illustrates an example signal diagram for uplink data transmission by the beamforming repeater of FIG. 1, according to some embodiments;

FIG. 8 illustrates an example signal diagram for channel state information reference signal (CSI-RS) transmission by the beamforming repeater of FIG. 1, according to some embodiments;

FIG. 9 illustrates an example signal diagram for sounding reference signal (SRS) transmission by the beamforming repeater of FIG. 1, according to some embodiments;

FIG. 10 illustrates an example architecture of a 5G NR hybrid beamforming repeater with control, according to some embodiments;

FIG. 11 illustrates an example of SSB allocations for the hybrid beamforming repeater of FIG. 10, according to some embodiments;

FIG. 12 illustrates an example protocol stack architecture for the repeater link, according to some embodiments;

FIG. 13 illustrates an example protocol stack architecture of a controller, according to some embodiments;

FIG. 14 illustrates an example signal diagram for SSB transmission by the hybrid beamforming repeater of FIG. 10, according to some embodiments;

FIG. 15 illustrates an example signal diagram for system information block 1 (SIB1) transmission by the hybrid beamforming repeater of FIG. 10, according to some embodiments;

FIG. 16 illustrates an example signal diagram for a random access procedure by the hybrid beamforming repeater of FIG. 10, according to some embodiments;

FIG. 17 illustrates an example signal diagram for downlink data transmission by the hybrid beamforming repeater of FIG. 10, according to some embodiments;

FIG. 18 illustrates an example signal diagram for uplink data transmission by the hybrid beamforming repeater of FIG. 10, according to some embodiments;

FIG. 19 illustrates an example signal diagram for CSI-RS transmission by the hybrid beamforming repeater of FIG. 10, where the CSI-RS is generated at the repeater, according to some embodiments;

FIG. 20 illustrates an example signal diagram for CSI-RS transmission by the hybrid beamforming repeater of FIG. 10, where the CSI-RS is amplified and forwarded by the repeater, according to some embodiments;

FIG. 21 illustrates an example signal diagram for SRS transmission by the hybrid beamforming repeater of FIG. 10, where the SRS transmission is over just an access link, according to some embodiments;

FIG. 22 illustrates an example signal diagram for SRS transmission by the hybrid beamforming repeater of FIG. 10, where the SRS is amplified and forwarded by the repeater, according to some embodiments;

FIG. 23 illustrates an example flow diagram of a method, according to some embodiments;

FIG. 24 illustrates an example flow diagram of a method, according to some embodiments;

FIG. 25 illustrates an example flow diagram of a method, according to some embodiments;

FIG. 26 illustrates an example flow diagram of a method, according to some embodiments;

FIG. 27a illustrates an example block diagram of an apparatus, according to an embodiment; and

FIG. 27b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for beamforming repeater with control channel is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar wording, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar wording, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Certain aspects of NR may apply to deployments in higher frequencies, such as around 4 gigahertz (GHz) for frequency range 1 (FR1) (e.g., 410 megahertz (MHz)-7125 MHz) and above 24 GHz in frequency range 2 (FR2) (e.g., 24250 MHz-52600 MHZ). In these higher frequencies, propagation characteristics are more challenging compared to deployments in lower frequencies. The higher path loss and high attenuation in the reflected and diffraction paths in these higher frequencies may have to be addressed through densification of the network with a larger number of cell sites and use of beamforming techniques to achieve the desired link budget. However, providing connectivity to all of the cells in such a dense deployment may not be possible either due to non-availability of wired backhaul or high cost of deploying the wired backhaul network.

Radio frequency (RF) repeaters have been used in 2G, 3G and 4G cellular networks to improve coverage using low-cost devices. Simple RF repeaters may be specified in certain aspects of NR. These repeaters may be low-cost relay devices and may operate in the half-duplex mode or full-duplex mode, amplifying and forwarding signals they receive from a base station or gNB. In full-duplex mode the signal amplification at the receiver may be limited by the isolation between its receive and transmit antennas. Considering the more severe deployment challenges for NR, similar relay devices may have to be used to provide coverage in a cost-effective way.

Some repeaters may not have beam forming capabilities and, as a result, may not be effective in coverage enhancements when deployed in NR networks where adaptive beamforming is used to compensate for higher path loss and increase spectral efficiency, particularly at higher frequencies. These repeaters may not have an effective mechanism to switch amplify and forward operations between the downlink and uplink transmissions of NR time division duplex (TDD) systems. In addition, any significant repeater delays may terminate the NR beam-based random access scheme, as well as the connected mode processes, including beam management and layer 3 (L3) mobility. Furthermore, repeaters for NR networks, particularly at higher frequencies, may have to use a large number of beams to cover wide areas that are beyond the coverage of the base station, and simultaneously, these repeaters may have to switch their amplify and forward operations between the downlink and uplink transmissions synchronously with a base station. There may also be a need for a repeater with adaptive beamforming for wide area coverage and dynamic TDD switching capabilities that does not result in any significant additional control plane or user plane latencies.

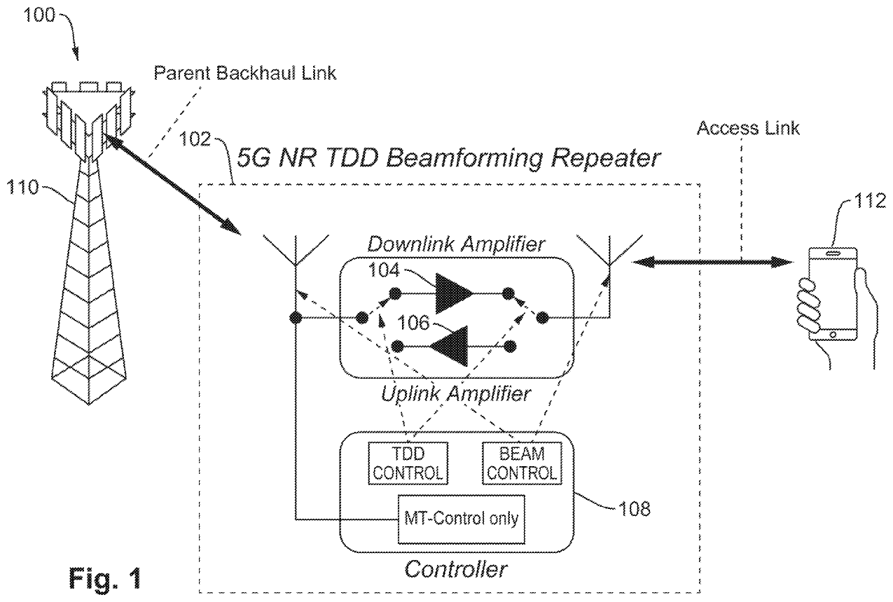

Some embodiments described herein may provide for a beamforming repeater with control channel or beamforming repeater with interfacing beam controller (e.g., illustrated in, and described with respect to FIGS. 1-9). The repeater may include a downlink amplifier, an uplink amplifier, and a control unit. The control unit may receive, from the donor, the access link transmit beam and receive beam configuration information and activation time periods for relaying the transmissions of downlink and uplink signals and channels, respectively. Based on the received downlink and uplink activation time periods, the control unit may switch between the downlink and uplink amplifiers, respectively. In the downlink activation period, the repeater may receive a signal from a donor or parent over its backhaul (BH) link, may amplify and then forward the signal over the access link using the transmit beam. Similarly, in the uplink activation period, the repeater may receive the signal from its access link using the receive beam, may amplify the signal and forward it to the donor/parent over the BH link.

For the periodic downlink transmissions such as SSBs, SIB1 signals, and CSI-RSs, the repeater's access link transmission beam and activation periods may be semi-statically configured by the donor. In addition, certain embodiments may apply to aperiodic signals, such as aperiodic CSI-RS. For dynamically scheduled downlink transmissions, such as downlink control channel (physical downlink control channel (PDCCH)) and data channel (physical downlink shared channel (PDSCH)), the transmission beam activation periods may be dynamically configured by the donor. For periodic uplink signals and channels, such as physical random access channel (PRACH) and sounding reference signal (SRS), the repeater's access link receive beam and their activation periods may be configured semi-statically by the donor. For dynamically scheduled uplink signals and channels, such as physical uplink control channel (PUCCH) and physical uplink shared channel (PUSCH), the access link receive beam and their activation periods may be configured dynamically.

Thus, certain embodiments described herein may enable adaptive beamforming capabilities for the access link of the repeaters. NR systems may use beam-formed channels to improve the link budget and increase spectral efficiency in high path loss circumstances, particularly at higher frequency bands, and the repeater may also use beamforming on its backhaul link to the donor gNB. The 1-to-1 mapping or re-use of the gNB beams by the repeater, as described herein, may make the random access channel (RACH) procedure transparent for the UE. In addition, certain embodiments may enable dynamic TDD capability at the repeater for accurate switching between downlink and uplink amplifiers with the downlink and uplink transmissions. TDD support may be important since NR may support TDD in FR1 and deployments in FR2 may just use TDD. Furthermore, certain embodiments may enable efficient multiplexing of downlink and uplink amplify-and-forward functions for the periods of transmissions of the corresponding channels and signals, which can help in significant noise and interference reduction in the network. In this way, certain embodiments may provide a repeater capable of dynamically adaptive beamforming in alignment with dynamically adaptive donor beamforming.

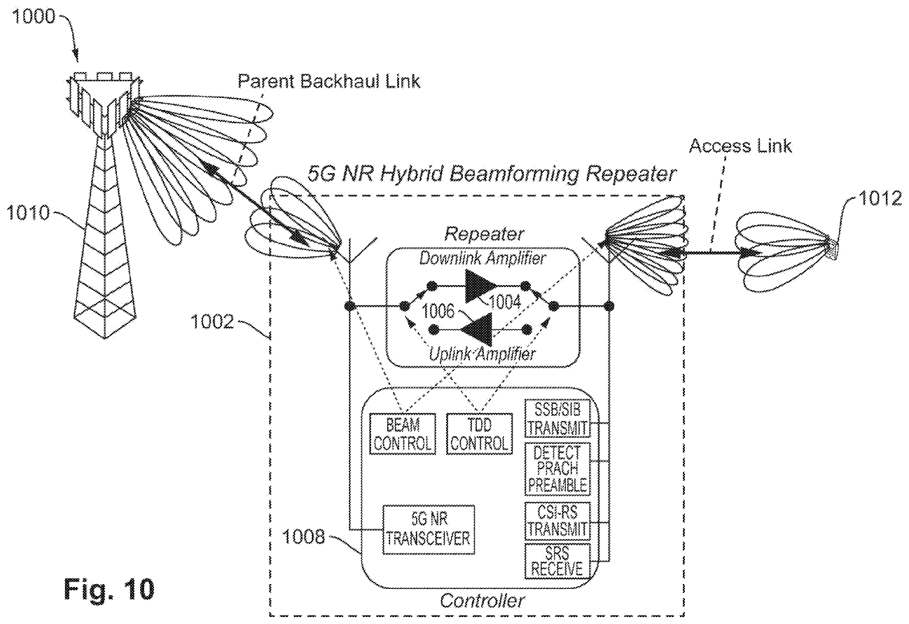

In addition, to the above, some embodiments described herein may provide for a hybrid beamforming repeater (e.g., illustrated in, and described with respect to FIGS. 10-22). The repeater may have its own independent cell resources, such as a physical cell identifier (PCI) and corresponding beam identifier space. The scheduling and beams of its cell-specific resources, such as SSBs, broadcast SIBs, RACH occasions, CSI-RS and SRS, may be configured by the donor gNB. The repeater may transmit its SSBs, periodic SIBs and CSI-RSs, detect PRACH preambles, and receive SRS, based on the configured schedules and beam information received from its donor.

The repeater may amplify and forward the downlink and uplink control and data channels, e.g., PDCCH, PDSCH, PUCCH, and PUSCH. The control unit may receive, from the donor, the access link transmit beam and receive beam configuration information, and may receive the activation time periods for relaying the transmissions of downlink and uplink signals and channels, respectively. For these channels, the donor gNB may use a scrambling sequence derived from the repeater's cell identifier (ID) for scrambling and de-scrambling of the downlink and uplink channels, respectively. For scenarios, such as semi-persistent transmissions of PDCCH, PDSCH, PUSCH, and PUCCH, the repeater may be semi-statically configured by the donor with the activation periods and access link beams. For the downlink channels, the repeater may receive the signal over its backhaul link from the donor gNB and then may amplify and forward the signal over its access link using the access link transmit beam. For the uplink channels, the repeater may receive the signal over child-access link receive beam, may amplify and then forward the signal over its backhaul link to the donor gNB.

Thus, certain embodiments may enable adaptive beamforming capabilities for the access link of the repeaters, which may enable use of a total number of beams as allowed in NR to provide wide area coverage and spectral efficiency. As explained above, NR systems may have to use beam-formed channels to improve the link budget due to high path loss, particularly at higher frequency bands. This can reduce the interference compared to repeaters using wider beams. As such, the repeater may also use beamforming on its backhaul link to the donor gNB, such that certain embodiments may support dynamically adaptive beamforming. In addition, certain embodiments may enable dynamic TDD capability at the repeater for accurate switching between downlink and uplink amplifiers with the downlink and uplink transmissions. TDD support may have to be used because NR supports TDD in FR1 and deployments in FR2 may be just TDD.

In addition, the amplify-and-forward functions for the data channels PDSCH and PUSCH can reduce the packet latencies compared to the regenerative integrated access and backhaul (IAB) relays that may have to decode and encode those channels. Furthermore, the hybrid repeater may be a low-cost device which provides the benefits of both RF repeater and IAB relays without having to use the full functionalities of an IAB node (e.g., the repeater may not have to have the backhaul access protocol (BAP) and radio link control (RLC) operations of an IAB node distributed unit (DU) and may not have to use full functions of the medium access control (MAC) layer, particularly the scheduler). In addition, the repeater may not have to have the low-density parity-check (LDPC) encoder or decoder for its access link PDSCH processing. Additionally, the repeater may not have digital-to-analog, and analog-to-digital converter blocks provisioned for PDSCH and PUSCH. Absence of these functions can reduce the cost and development time for the repeater.

In addition, in this way, certain embodiments described herein may provide a low-cost repeater design for 5G NR networks that has adaptive beamforming and TDD capability. Certain embodiments may improve beamforming repeaters with control links, by reducing or eliminating the need to sacrifice a large portion of the available beam space in the parent cell (donor gNB), in order to be transparent during the RACH procedure for UEs (e.g., in FR1, which may be limited to 8 SSB beams, where steering of 4 or more beams in the direction of the repeater may not be viable).

FIG. 1 illustrates an example architecture 100 of a beamforming repeater with control channel, according to some embodiments. The example 100 includes a 5G NR TDD repeater 102 that includes a downlink amplifier 104, an uplink amplifier 106, and controller 108. The example 100 also includes a gNB 110 and a UE 112.

The control unit, controller (SC) 108, may include a 5G NR receiver, a TDD control unit, and a beam control unit. The 5G NR receiver may be a 5G NR UE, a 5G NR IAB-mobile terminal (MT) or a reduced capability UE and/or IAB-MT with just user plane and potentially limited control plane functions. The 5G NR receiver may receive the repeater configuration information from the gNB 110, and may provide the required information to the TDD and beam control units. The information can be delivered using the backhaul beam between the donor and the repeater 102 or via a separate out-of-band link. The backhaul beam between the donor 110 and the repeater 102 can be configured and managed using the NR beam management techniques for the UE or IAB-MT when the repeater 102 is integrated in the network by assuming correspondence between control plan beams and data plane beams.

As described above, FIG. 1 is provided as an example. Other examples are possible, according to some embodiments.

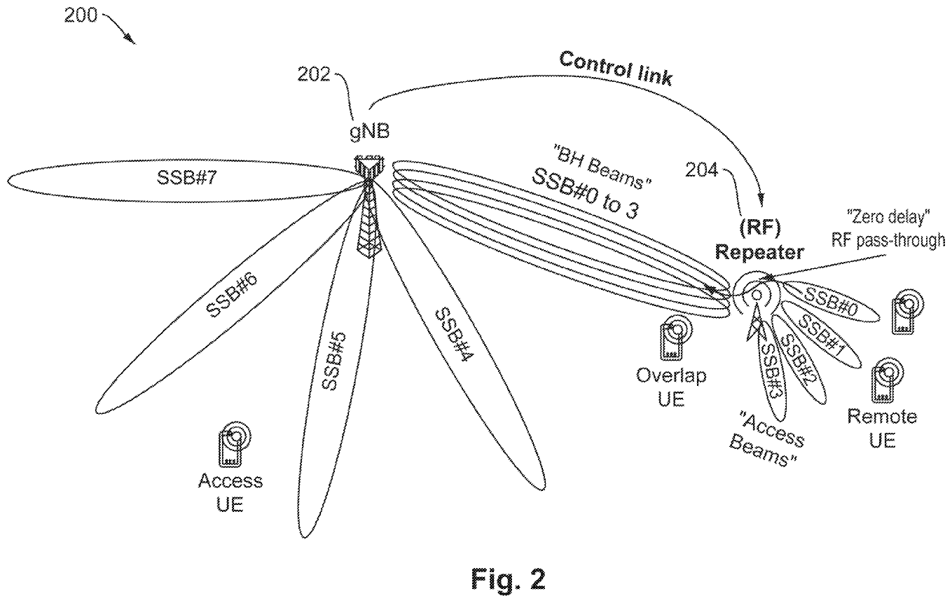

The repeaters, controllers, donor gNBs, UEs, etc. illustrated in, and described with respect to, FIGS. 2-9 may be similar to the repeater 102, controller 108, donor gNB 110, UE 112, etc. of FIG. 1, even though they are labeled with different reference numbers.

FIG. 2 illustrates an example 200 of synchronization signal block (SSB) allocations in the beamforming repeater of FIG. 1, according to some embodiments. As illustrated in FIG. 2, the example 200 includes a gNB 202 and an RF repeater 204. The repeater 204 of the (donor) gNB 202 may extend the coverage area of the (donor) cell, and the SSB beams for repeater 204 may be allocated from the donor cell's SSB beam identifier space as illustrated in FIG. 2. In this example, the SSB #0-SSB #3 may be allocated to the repeater 204 for its coverage area, and the remaining SSB beams SSB #4-SSB #7 may be used by the donor gNB 202 for its coverage area.

As indicated above, FIG. 2 is provided as an example. Other examples are possible, according to some embodiments.

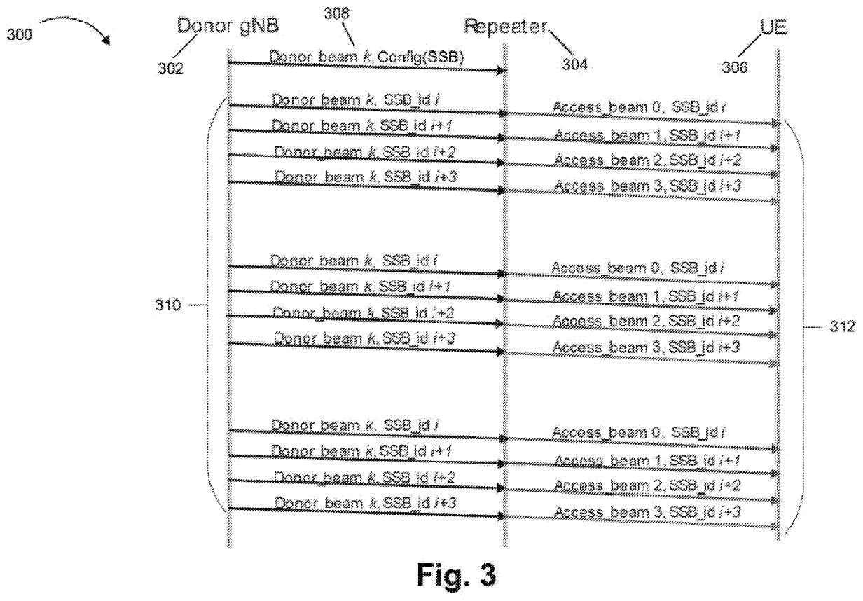

FIG. 3 illustrates an example signal diagram 300 for SSB transmission by the beamforming repeater of FIG. 1, according to some embodiments. As illustrated in FIG. 3, the example signal diagram 300 illustrates a donor gNB 302, a repeater 304, and a UE 306.

The repeater 304 may, at 308, receive semi-static configuration information for the SSBs it relays from the donor gNB 302. The configuration information may include the following for each SSB: scheduling of resources for the SSB, access link transmission beam configuration (the repeater 304 can also be allowed to select beams freely within the SSB indices allocated by the gNB 302 to repeater 304 communication), and periodicity.

The repeater 304 may receive the SSB signal as scheduled, at 310, may amplify it, and may forward it, at 312, using the configured access link transmit beam. In FIG. 3, the SSB identifiers i, i+1, i+2, and i+3 may be allocated for the repeater 304. The donor gNB 302 may transmit these SSBs over the backhaul beam k, the repeater may amplify and forward these SSBs i, i+1, i+2, and i+3 over its access beams 0, 1, 2, and 3, respectively.

As described above, FIG. 3 is provided as an example. Other examples are possible, according to some embodiments.

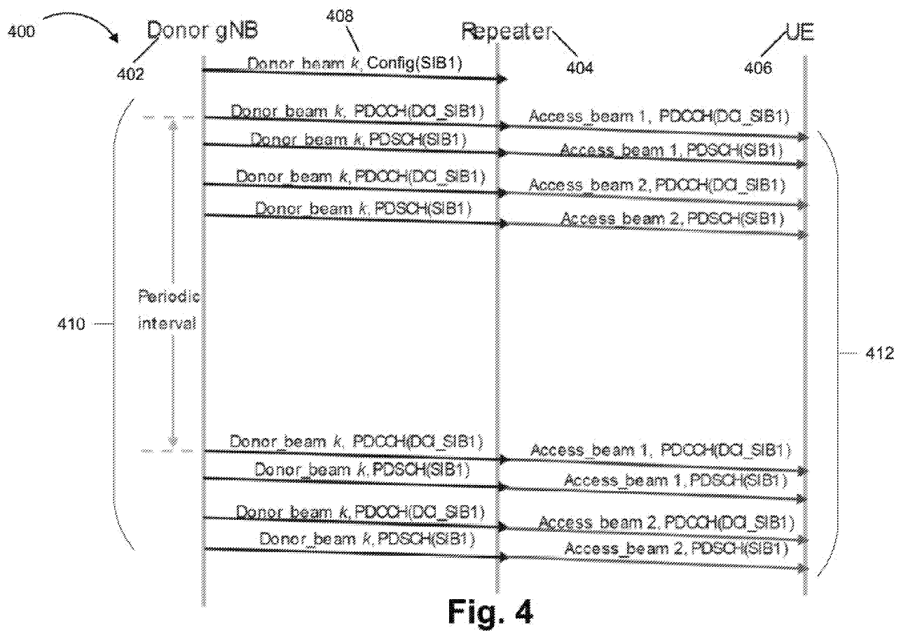

FIG. 4 illustrates an example signal diagram 400 for system information block 1 (SIB1) transmission by the beamforming repeater of FIG. 1, according to some embodiments. As illustrated in FIG. 4, the example signal diagram 400 includes a donor gNB 402, a repeater 404, and a UE 406.

The relaying operations for SIB1 may also be semi-statically configured at the repeater 404 by donor gNB 402, as illustrated at 408. The configuration information may include scheduling information of SIB1: time-frequency resources for PDCCH transmission comprising downlink control information (DCI) and the PDSCH transmission comprising SIB1, access link transmit beam configuration for the PDCCH and PDSCH, and periodicity. For example, the SSB configuration in FIG. 3 above may describe the mapping of SSB index to repeater's access link beam. SIB1 may also be transmitted using the same set of beams used for SSBs or a subset of it. To configure the repeater for SIB1 forwarding, the donor may identify the SSB index for an SIB1 transmission. The repeater may then determine the access link beam from the mapping of SSB index to access link beam established by the SSB configuration message in FIG. 3 above. The repeater 404 may receive the PDCCH and PDSCH transmissions from the donor, at 410, as scheduled, may amplify the received signalling, and may forward the singling, at 412, using the access link transmit beam as configured.

As described above, FIG. 4 is provided as an example. Other examples are possible, according to some embodiments.

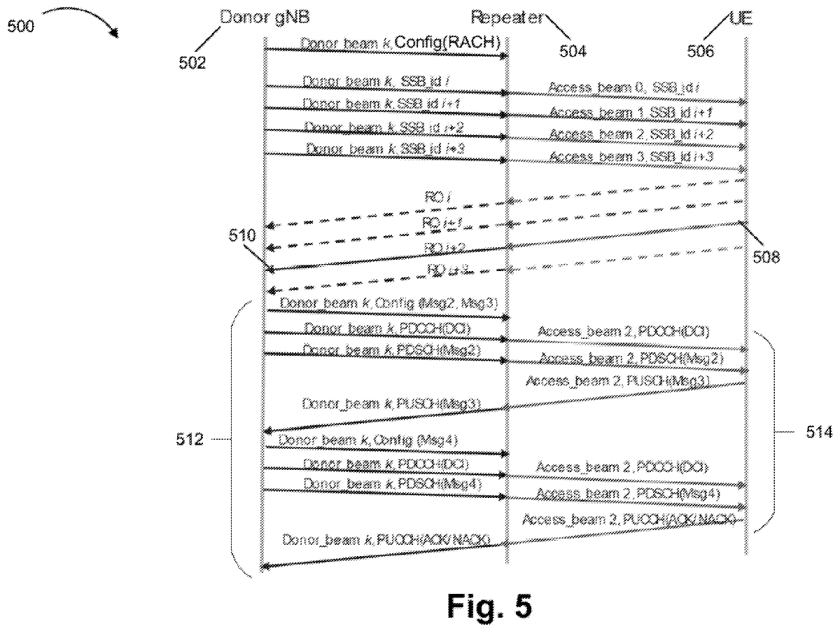

For the initial access procedure, the repeater may be configured semi-statically with the parameters for the RACH occasions. These configured parameters may include resource allocation and periodicity for each RACH occasion and/or access link receive beam configuration for each RACH occasion. The configurations for the message 2 (Msg2), message 3 (Msg3), and message 4 (Msg4) of the RACH procedure may be provided to the repeater dynamically. As shown in FIG. 5, configurations for Msg2 and Msg3 can be sent in one message, which may include resource allocations and transmit beams for PDCCH for DCI, PDSCH for Msg2 and/or resource allocation and receive beam for PUSCH for Msg3. The configurations for Msg4 may be sent before it is scheduled. These configurations may include resource allocation and transmit beam for PDCCH for DCI and PDSCH for Msg4 and resource allocation and receive beam for hybrid automatic repeat request (HARQ) feedback.

FIG. 5 illustrates an example signal diagram 500 for a random access procedure by the beamforming repeater of FIG. 1, according to some embodiments. As illustrated in FIG. 5, the example signal diagram 500 includes a donor gNB 502, a repeater 504, and a UE 506. In the example signal diagram 500, the UE 506 may select the access beam 2 as the strongest beam and may transmit the PRACH preamble in the RACH occasion corresponding to the SSB identifier i+2, as illustrated at 508. The repeater 504 may amplify and forward the PRACH preamble, as illustrated at 510. Subsequent RACH procedure messages, Msg2, Msg3, Msg4, and the HARQ ACK may be transmitted and received by the repeater 504, as illustrated at 512 and 514, using the access beam 2 for the downlink and the corresponding receive beam on the uplink.

As described above, FIG. 5 is provided as an example. Other examples are possible, according to some embodiments.

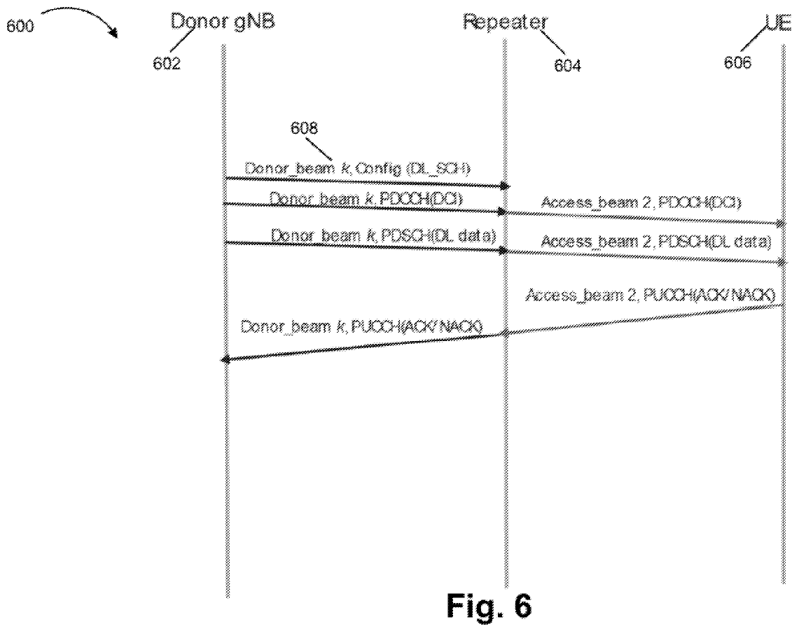

FIG. 6 illustrates an example signal diagram 600 for downlink data transmission by the beamforming repeater of FIG. 1, according to some embodiments. As illustrated in FIG. 6, the example signal diagram 600 includes a donor gNB 602, a repeater 604, and a UE 606.

Dynamically scheduled downlink and uplink shared channels may be configured at the repeater 604 dynamically. The configuration and transmission procedures for downlink shared channel (DL-SCH) is illustrated in FIG. 6, where, at 608, the DL-SCH is dynamically configured at the repeater 604. For DL-SCH, the donor gNB 602 may send the configuration message to the repeater 604 including resource allocations and access link transmit beams for PDCCH and PDSCH and/or resource allocation and access link receive beam for HARQ acknowledge (ACK) or negative ACK (NACK). If the PDSCH transmission is scheduled on downlink symbols of the frame, then the repeater may have link direction from TDD configuration received by the controller. If it is scheduled on flexible symbols, the repeater 604 may monitor for DCI format 2_0 to receive dynamic indication of link directions. For beam configuration indication for PDCCH and PDSCH, another DCI format may be used.

As described above, FIG. 6 is provided as an example. Other examples are possible, according to some embodiments.

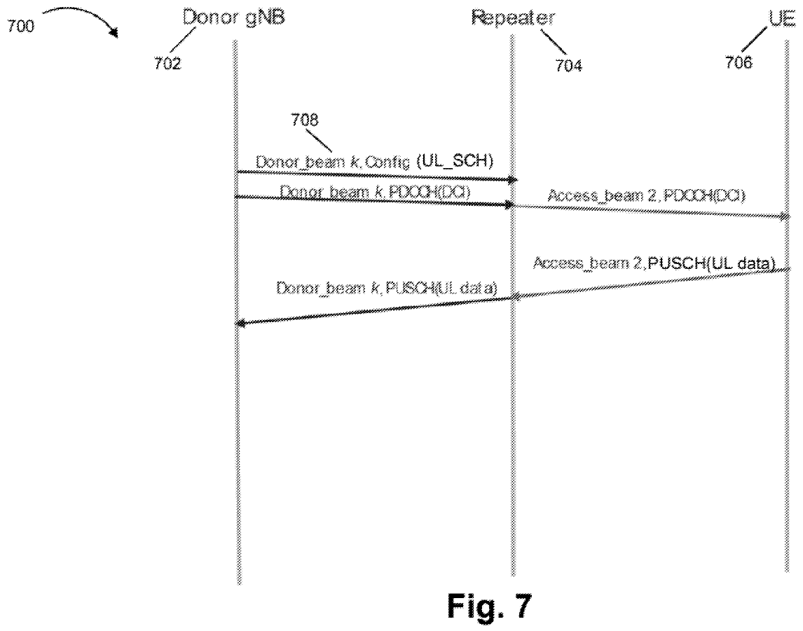

FIG. 7 illustrates an example signal diagram 700 for uplink data transmission by the beamforming repeater of FIG. 1, according to some embodiments. As illustrated in FIG. 7, the example signal diagram 700 includes a donor gNB 702, a repeater 704, and a UE 706. The uplink shared channel (UL-SCH) configuration illustrated at 708 may include resource allocations and access link transmit beams for PDCCH and/or resource allocation and access link receive beam for PUSCH. In some embodiments, the controller may acquire the cell radio network temporary identifiers (C-RNTIs) of the UEs 706 attached to the repeater 704 during the RACH procedure by intercepting and decoding the Msg2, Msg3, and Msg4. The controller may receive the resource allocation and access link beam configuration for the PDCCH from the gNB 702. Then, it may decode the PDCCH to determine the resource allocation and receiving beam based on the detected C-RNTI.

As described above, FIG. 7 is provided as an example. Other examples are possible, according to some embodiments.

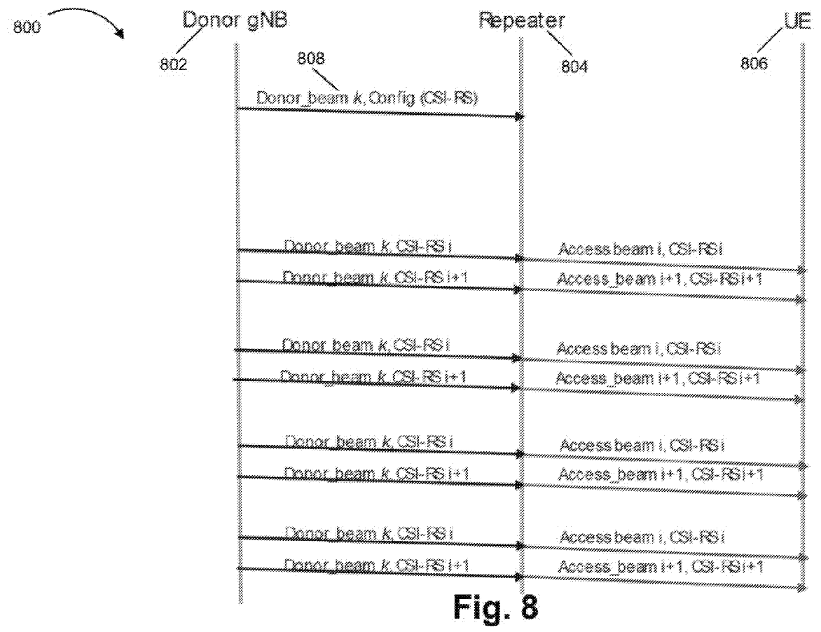

FIG. 8 illustrates an example signal diagram 800 for channel state information reference signal (CSI-RS) transmission by the beamforming repeater of FIG. 1, according to some embodiments. As illustrated in FIG. 8, the example signal diagram 800 may include a donor gNB 802, a repeater 804, and a UE 806.

The donor gNB 802 may generate the CSI-RS signals to be relayed by the repeater 804 using its transmit beam. The donor gNB 802 may send configuration parameters for the CSI-RS signals at 808. The configuration parameters sent by the donor gNB 802 to the repeater 804 may include resource allocation for CSI-RS and/or access link transmit beam configuration for CSI-RS signals. For periodic and semi-persistent CSI-RS signals, the repeater 804 may be semi-statically configured for relaying the signals and the configuration parameter may also include the starting time and periodicity of CSI-RS signals. The controller may acquire these configurations from the SIB and radio resource control (RRC) messages transmitted by the gNB 802. In this way, the example semi-static configuration of the repeater for CSI-RS transmissions is illustrated in FIG. 8.

As described above, FIG. 8 is provided as an example. Other examples are possible, according to some embodiments.

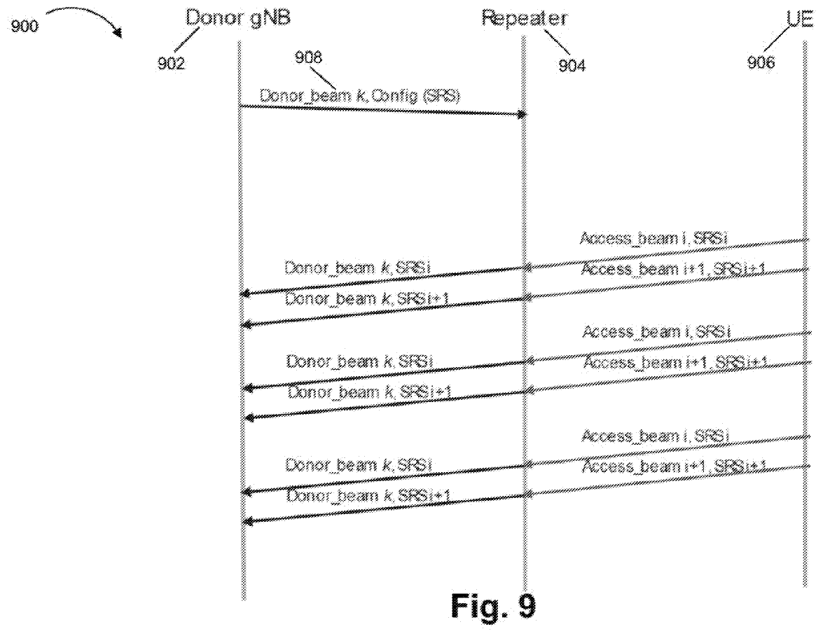

FIG. 9 illustrates an example signal diagram 900 for sounding reference signal (SRS) transmission by the beamforming repeater of FIG. 1, according to some embodiments. As illustrated in FIG. 9, the example signal diagram 900 includes a donor gNB 902, a repeater 904, and a UE 906. The repeater 904 may relay the SRS signals received from the UEs 906. In addition, the repeater 904 may receive, at 908, configuration parameters from the donor gNB 902. The configuration parameters may include a resource allocation for SRS and/or an access link receive beam configuration for SRS signals. For periodic and semi-persistent SRS signals, the repeater 904 may be semi-statically configured for relaying the signals, and the configuration parameters may also include the starting time and periodicity of SRS signals. The controller may acquire these configurations from the SIB and RRC messages transmitted by the gNB 902.

As described above, FIG. 9 is provided as an example. Other examples are possible, according to some embodiments.

In this way, certain embodiments described with respect to FIGS. 1-9 may provide various benefits. For example, the adaptive access link beamforming capability of the repeater may improve the access link budget and/or enable mobility for UEs attached to the repeater. Additionally, or alternatively, the repeater beamforming capability on the BH link may increase the BH link capacity and cell coverage. Additionally, or alternatively, The TDD control may help to accurately synchronize the switching between the downlink and uplink amplifiers with the downlink and uplink transmissions.

FIG. 10 illustrates an example architecture 1000 of a 5G NR hybrid beamforming repeater with control, according to some embodiments. As illustrated in FIG. 10, the example 1000 includes a 5G NR hybrid repeater 1002 that includes a downlink amplifier 1004, an uplink amplifier 1006, and a controller 1008. The example 1000 also includes a gNB 1010 and a UE and/or IAB-MT 1012.

The control unit, controller (SC) 1008, may include a 5G NR transceiver, a TDD control unit, and a beam control unit. The 5G NR transceiver may be a 5G NR UE, a 5G NR IAB-MT, or a reduced capability UE and/or IAB-MT with just user plane and potentially limited control plane functions. The 5G NR transceiver may receive the repeater configuration information from the gNB 1010, and may provide the configuration information to the TDD and beam control units. The information may be delivered using the backhaul beam between the donor gNB 1010 and the repeater 1002. The backhaul beam between the donor gNB 1010 and the repeater 1002 may be configured and managed using one or more beam management techniques for the UE or IAB-MT 1012 when the repeater 1002 is integrated in the network by assuming correspondence between control plan beams and data plane beams.

Other components of the repeater 1002 illustrated in FIG. 10 may include an SSB and/or SIB transmitter that may transmit SSBs and/or may broadcast SIBs, a PRACH preamble detector that may detect PRACH preambles and may forward the detected information to the donor gNB 1010 (e.g., the forwarded information may include a preamble identifier, a random access RNTI (RA-RNTI), and/or a temporary C-RNTI (TC-RNTI)), a CSI-RS transmitter that may transmit CSI-RS signals, and/or a SRS receiver that may receive SRS signals and may forward the SRS information to the donor gNB 1010 (e.g., the SRS information may include layer 1 (L1) measurement reports, which may be filtered). The control link between the donor gNB 1010 and the controller 1008 may be transparent to the UE 1012 and it may be based on any other radio access technologies (RATs) and may need not be limited to NR RAT.

As described above, FIG. 10 is provided as an example. Other examples are possible, according to some embodiments.

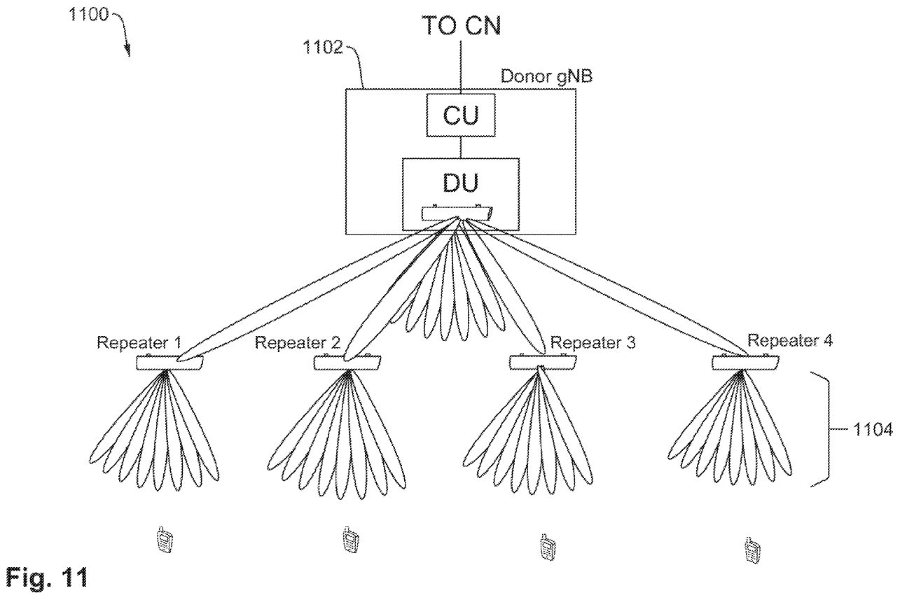

The repeaters, controllers, donor gNBs, UEs, etc. illustrated in, and described with respect to, FIGS. 11-22 may be similar to the repeater 1002, controller 1008, donor gNB 1010, UE 1012, etc. of FIG. 10, even though they are labeled with different reference numbers.

FIG. 11 illustrates an example 1100 of SSB allocations for the hybrid beamforming repeater of FIG. 10, according to some embodiments. As illustrated in FIG. 11, the example 1100 includes a donor gNB 1102, which includes a central unit (CU) and a DU, and that is connected to a core network (CN). As further illustrated, the DU is connected to four repeaters, labeled as “Repeater 1,” “Repeater 2,” “Repeater 3,” and “Repeater 4.” Each of the repeaters may transmit a set of SSB beams 1104. The repeaters may have their own beam identifier space which may be compliant with the NR SSB architecture. Scheduling of the SSB transmissions of a repeater may be controlled by the donor gNB 1102.

As described above, FIG. 11 is provided as an example. Other examples are possible, according to some embodiments.

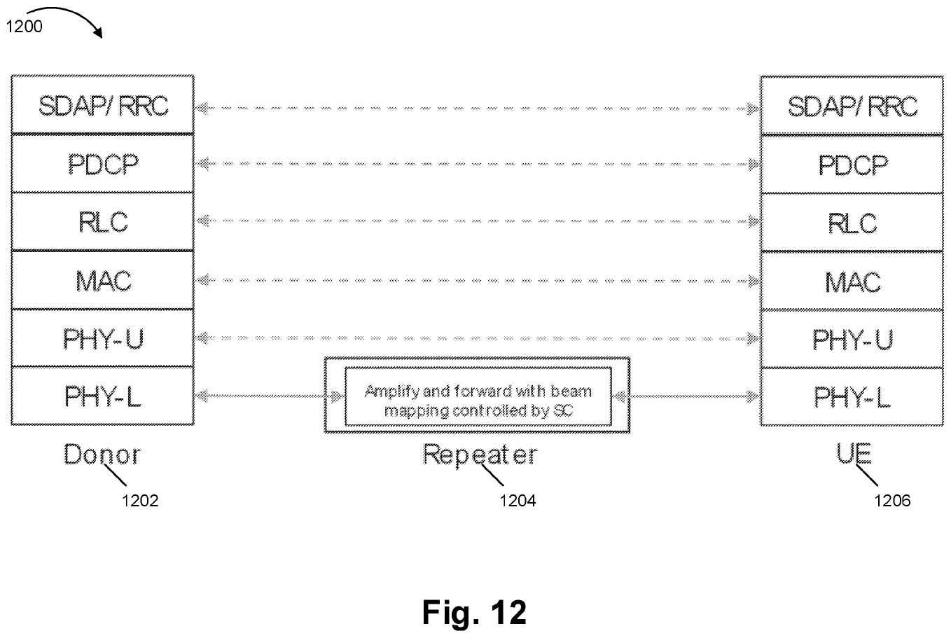

FIG. 12 illustrates an example protocol stack architecture 1200 for the repeater link, according to some embodiments. The example illustrated in FIG. 12 includes a donor gNB 1202, a repeater 1204, and a UE 1206. Each of the donor gNB 1202 and the UE 1206 may be associated with a protocol stack that includes a lower physical layer (PHY-L) (e.g., MIMO beamforming or radio frequency transceiving operations), an upper physical layer (PHY-U) (e.g., channel encoding or decoding or hybrid automatic repeat request (HARQ) processing), a MAC layer, a radio link control (RLC) layer, a packet data convergence protocol (PDCP) layer, and a service data adaption protocol (SDAP) layer and/or a radio resource control (RRC) layer. Each of the protocol stacks may be an end-to-end protocol stack architecture for the repeater link. The repeater 1204 may amplify the signal and may then forward signalling over the beam of the outgoing link, e.g., the access link beam for downlink transmissions and BH link beam for uplink signal.

As described above, FIG. 12 is provided as an example. Other examples are possible, according to some embodiments.

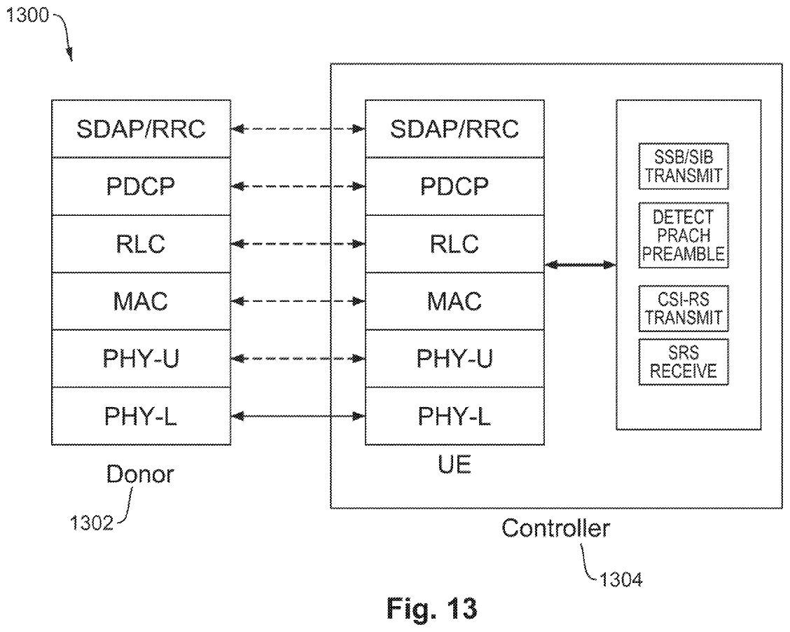

FIG. 13 illustrates an example protocol stack architecture 1300 of a controller, according to some embodiments. FIG. 13 illustrates a donor gNB 1302 and a controller 1304. The full protocol stack of an NR UE may be used in the controller to receive the control and configuration information from the donor gNB 1302 for the repeater and the access link signal generators and detectors.

As described above, FIG. 13 is provided as an example. Other examples are possible, according to some embodiments.

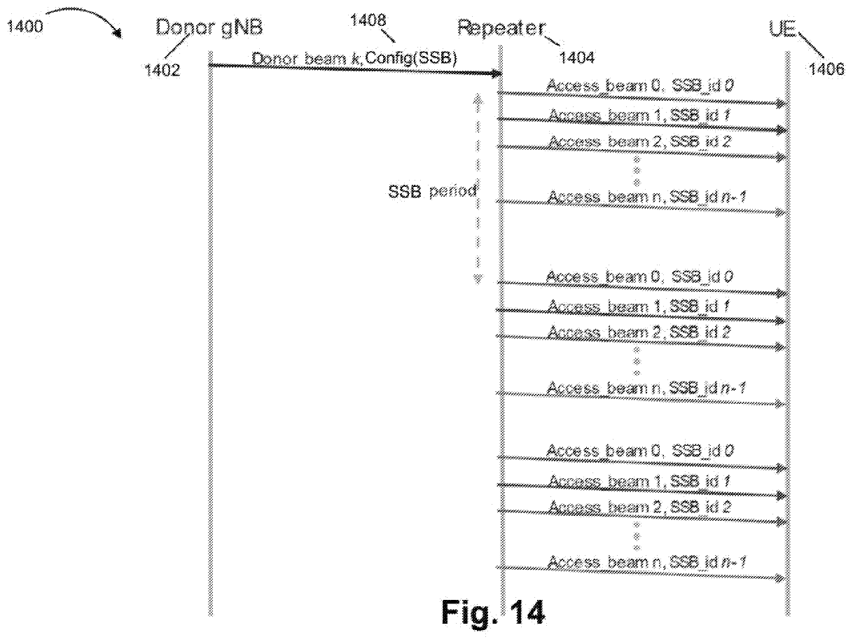

FIG. 14 illustrates an example signal diagram 1400 for SSB transmission by the hybrid beamforming repeater of FIG. 10, according to some embodiments. As illustrated in FIG. 14, the example signal diagram 1400 includes a donor gNB 1402, a repeater 1404, and a UE 1406.

The repeater may receive, at 1408, the semi-static configuration information for the SSBs it transmits periodically. The configuration information may include scheduling of resources for the SSBs, access link transmission beam configuration (e.g., the repeater can also be allowed to allocate beams freely within the SSB indices used by the gNB to repeater communication), periodicity, repeater cell identifier, and/or master information block (MIB) information. Alternatively, the repeater 1404 may obtain the MIB from a look-up table.

The repeater 1404 may transmit its SSB signals as scheduled using its SSB beams and its cell identifier. The repeater 1404 may transmit its n SSB signal over n beams, identified by SSB_id 0, . . . , SSB_id n−1.

As described above, FIG. 14 is provided as an example. Other examples are possible, according to some embodiments.

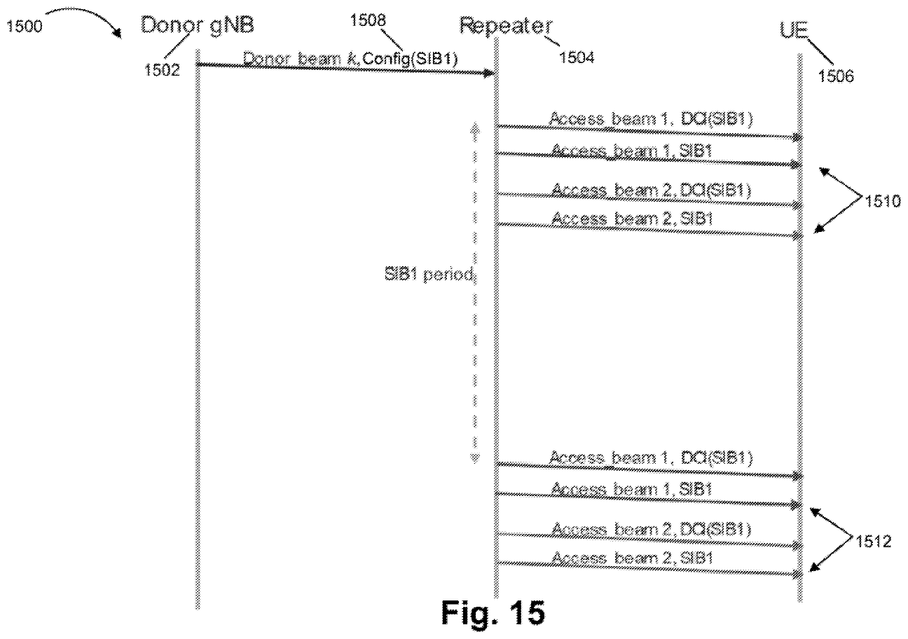

FIG. 15 illustrates an example signal diagram 1500 for system information block 1 (SIB1) transmission by the hybrid beamforming repeater of FIG. 10, according to some embodiments. As illustrated in FIG. 15, the example signal diagram 1500 includes a donor gNB 1502, a repeater 1504, and a UE 1506. Transmission of SIB1 may be semi-statically configured at the repeater 1504 by the donor gNB 1502, as illustrated at 1508. The configuration information may include scheduling information of the SIB1 (e.g., time-frequency resources for PDCCH transmission containing DCI and the PDSCH transmission containing SIB1), access link transmit beam configuration for the PDCCH and PDSCH, periodicity, SIB1 content (e.g., if the repeater may not have encoder and/or decoder for PDSCH, the donor gNB 1502 may provide the encoded bits-stream to the repeater 1504). Alternatively, the repeater 1504 may obtain the SIB1 from a look-up table. The repeater 1504 may transmit the SIB1 as scheduled over its access link beams as configured, as illustrated in FIG. 15 at 1510 and 1512.

As described above, FIG. 15 is provided as an example. Other examples are possible, according to some embodiments.

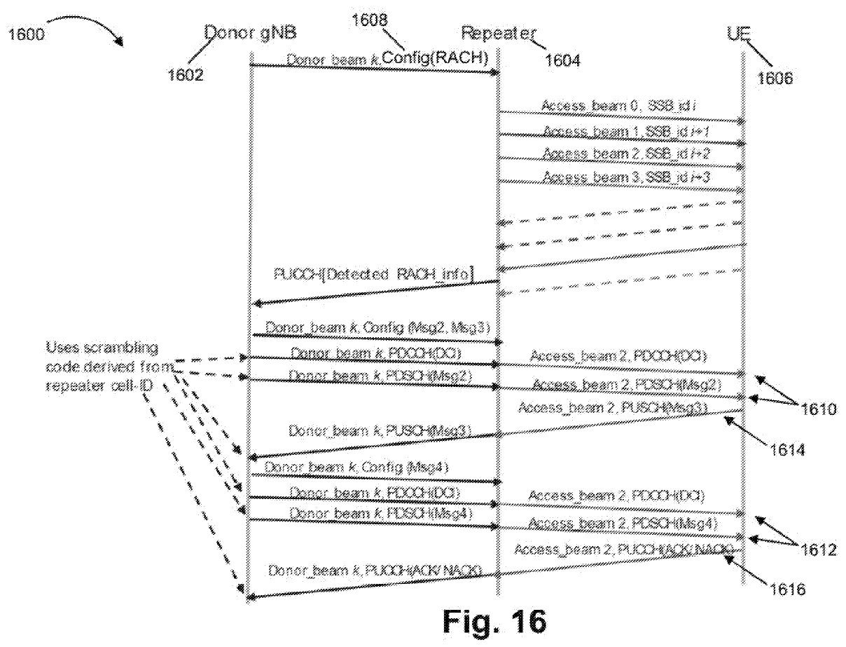

FIG. 16 illustrates an example signal diagram 1600 for a random access procedure by the hybrid beamforming repeater of FIG. 10, according to some embodiments. As illustrated in FIG. 16, the example signal diagram 1600 includes a donor gNB 1602, a repeater 1604, and a UE 1606. For the initial access procedure, the repeater 1604 may be configured semi-statically by the donor gNB 1602 with the parameters for the RACH occasions. The configured parameters may include resource allocation and periodicity for each RACH occasion and/or receiver beam configuration for each RACH occasion. The repeater 1604 may detect PRACH preambles on those RACH occasions and may forward the detected RACH information to the donor gNB 1602 over a PUCCH, which may include the detected preamble identifier, RA-RNTI, and TC-RNTI to be used for Msg2.

The configurations for the Msg2, Msg3 and Msg4 of the RACH procedure may be provided to the repeater 1604 dynamically by the donor gNB 1602. The configurations for Msg2 and Msg3 may be sent in a message, at 1608. The message may include resource allocations and transmit beams for PDCCH for DCI and/or PDSCH for Msg2 and/or resource allocation and receive beam for PUSCH for Msg3. After successful decoding of Msg3, the donor gNB 1602 may send the configurations for Msg4. The configurations may include resource allocation and transmit beam for PDCCH for DCI and PDSCH for Msg4 and/or resource allocation and receive beam for HARQ feedback over PUCCH.

The repeater 1604 may receive the DCIs, Msg2, and Msg4 over its backhaul link beam, may amplify and may forward them over the corresponding configured access link transmit beams, as illustrated at 1610 and 1612. The repeater may receive Msg3 and the HARQ feedback over the configured access link receive beam, at 1614 and 1616, and may amplify and forward it over its backhaul link beam. For these downlink and uplink messages, the donor gNB 1602 may use the scrambling code derived from the cell identifier of the repeater 1604 for transmission and reception, respectively.

In the example 1600 illustrated in FIG. 16, the UE 1606 may select the access beam 2 as the strongest beam and may transmit the PRACH preamble in the RACH occasion corresponding to the SSB identifier i+2. The repeater may detect the PRACH preamble and may forward the preamble identifier and any other RACH information to the donor gNB 1602 over PUCCH, which may be pre-allocated. Subsequent RACH procedure messages Msg2, Msg3, Msg4, and the HARQ ACK may be transmitted and received by the repeater 1604 using the access beam 2 for the downlink and the corresponding receive beam on the uplink.

As described above, FIG. 16 is provided as an example. Other examples are possible, according to some embodiments.

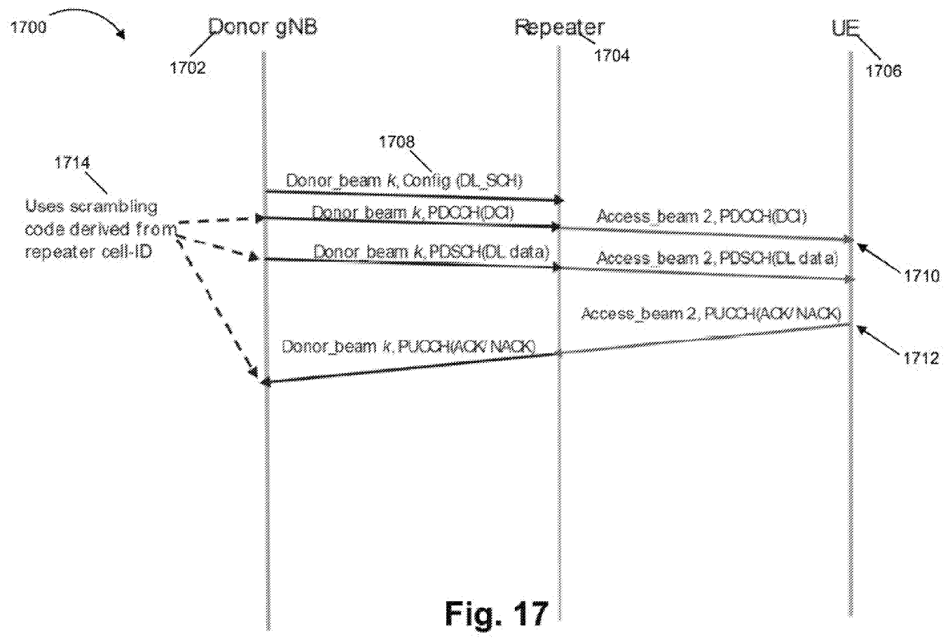

FIG. 17 illustrates an example signal diagram 1700 for downlink data transmission by the hybrid beamforming repeater of FIG. 10, according to some embodiments. As illustrated in FIG. 17, the example signal diagram 1700 includes a donor gNB 1702, a repeater 1704, and a UE 1706.

Dynamically scheduled downlink and uplink shared channels may be configured at the repeater dynamically. The configuration and transmission procedures for DL-SCH is illustrated at 1708. For DL-SCH, the donor gNB 1702 may send the configuration message to the repeater 1704 including resource allocations and access link transmit beams for PDCCH and PDSCH and/or resource allocation and access link receive beam for HARQ ACK/NACK. The repeater 1704 may receive the DCI and DL data over its backhaul link beam, may amplify and forward them over the corresponding configured access link transmit beams, at 1710. The repeater 1704 may receive the HARQ feedback over the configured access link receive beam, and may amplify and forward it over its backhaul link beam, at 1712. For these downlink and uplink messages, the donor gNB 1702 may use the scrambling code derived from the cell identifier of the repeater 1704 for transmission and reception, respectively, as illustrated at 1714. If the PDSCH transmission is scheduled on downlink symbols of the frame, then the repeater 1704 may have link direction from TDD configuration received by the controller. If it is scheduled on flexible symbols, the repeater 1704 may monitor for DCI format 2_0 to receive dynamic indication of link directions. For beam configuration indication for PDCCH and PDSCH, a new DCI format may be used.

As described above, FIG. 17 is provided as an example. Other examples are possible, according to some embodiments.

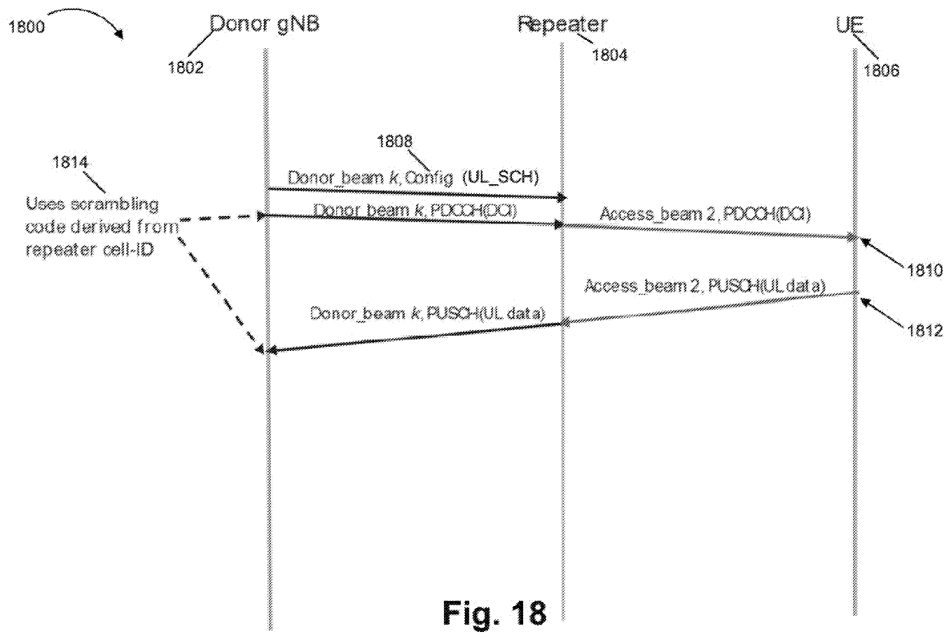

FIG. 18 illustrates an example signal diagram 1800 for uplink data transmission by the hybrid beamforming repeater of FIG. 10, according to some embodiments. As illustrated in FIG. 18, the example signal diagram 1800 includes a donor gNB 1802, a repeater 1804, and a UE 1806. For UL-SCH, the configuration message to the repeater 1804, at 1808, may include resource allocations and access link transmit beams for PDCCH and/or resource allocation and access link receive beam for PUSCH. The repeater 1804 may receive the DCI over its backhaul link beam, and may amplify and forward the DCI over the corresponding configured access link transmit beams, as illustrated at 1810. The repeater 1804 may receive the UL data over the configured access link receive beam, and may amplify and forward it over its backhaul link beam, as illustrated at 1812. For these downlink and uplink messages, the donor gNB 1802 may use the scrambling code derived from the cell identifier of the repeater 1802 for transmission and reception, respectively, as illustrated at 1814. In an alternative embodiment, the controller may acquire the C-RNTIs of the UEs 1806 attached to the repeater 1804 during the RACH procedure by intercepting and decoding the Msg2, Msg3, and Msg4. The controller may receive the resource allocation and access link beam configuration for the PDCCH from the gNB 1802. Then, it may decode the PDCCH to determine the resource allocation and receive beam based on the detected C-RNTI.

As described above, FIG. 18 is provided as an example. Other examples are possible, according to some embodiments.

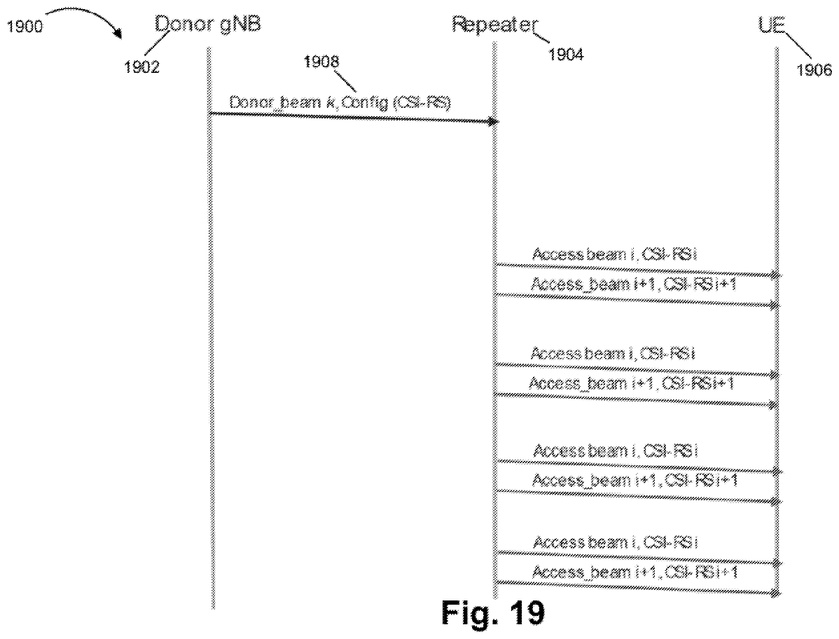

FIG. 19 illustrates an example signal diagram 1900 for CSI-RS transmission by the hybrid beamforming repeater of FIG. 10, where the CSI-RS is generated at the repeater, according to some embodiments. As illustrated in FIG. 19, the example signal diagram 1900 includes a donor gNB 1902, a repeater 1904, and a UE 1906.

The donor gNB 1902 may send a CSI-RS configuration to the repeater 1904, at 1908. The configuration may include resource allocation for CSI-RS and/or access link transmit beam configurations from CSI-RS signals. Thus, FIG. 19 may illustrate semi-static configuration of the repeater 1904 for CSI-RS transmissions. For periodic and semi-persistent CSI-RS signals, the repeater 1904 may be semi-statically configured to generate the signals and the configuration parameter may also include the starting time and periodicity of CSI-RS signals. The controller may acquire these configurations from the SIB and RRC messages transmitted by the gNB 1902.

As described above, FIG. 19 is provided as an example. Other examples are possible, according to some embodiments.

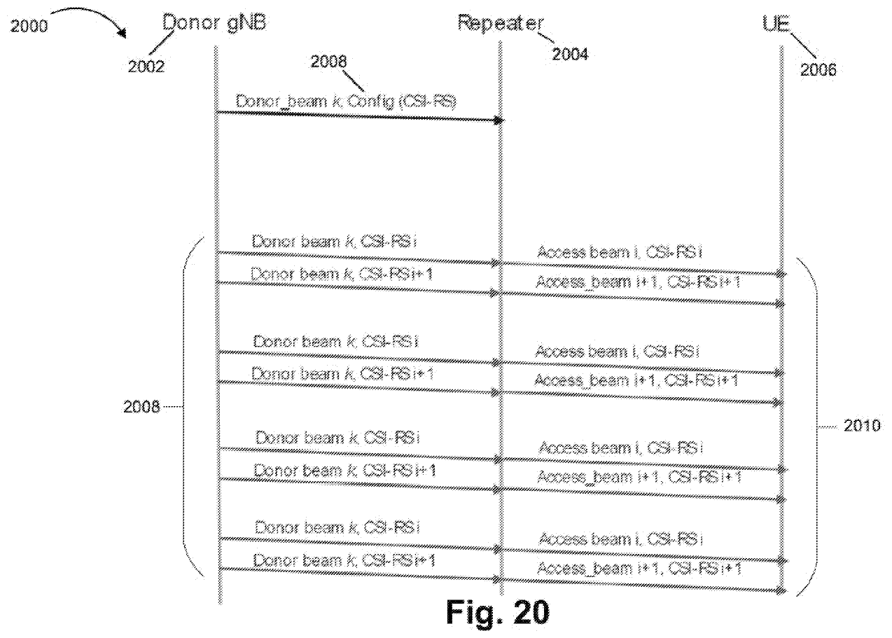

FIG. 20 illustrates an example signal diagram 2000 for CSI-RS transmission by the hybrid beamforming repeater of FIG. 10, where the CSI-RS is amplified and forwarded by the repeater, according to some embodiments. As illustrated in FIG. 20, the example signal diagram 2000 includes a donor gNB 2002, a repeater 2004, and UE 2006.

In an alternative to certain embodiments illustrated in FIG. 19, the donor gNB 2002 may transmit the CSI-RS signals over the BH link at the allocated resources, at 2008. The repeater 2004 may then amplify and forward the CSI-RS signals at the allocated resources using the configured access link beam, at 2010. This may be for a semi-static configuration. Transmission of the CSI-RS signals over both the BH and access links may be needed to obtain a more accurate multiple input multiple output (MIMO) channel state between the donor gNB 2002 and UE 2006 for FR1 deployments.

As described above, FIG. 20 is provided as an example. Other examples are possible, according to some embodiments.

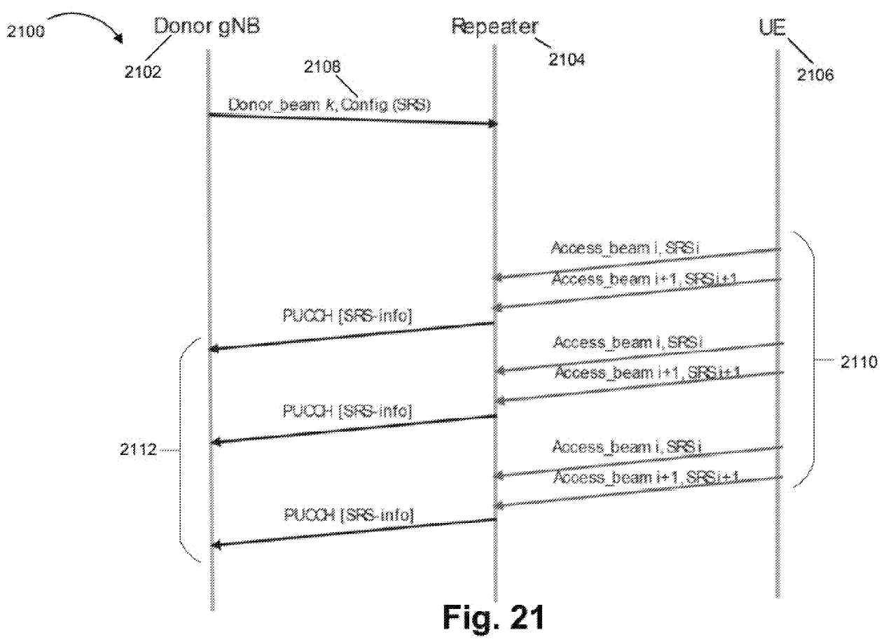

FIG. 21 illustrates an example signal diagram 2100 for SRS transmission by the hybrid beamforming repeater of FIG. 10, where the SRS transmission is over just an access link, according to some embodiments. As illustrated in FIG. 21, the example signal diagram 2100 includes a donor gNB 2102, a repeater 2104, and a UE 2106.

The donor gNB 2102 may send configuration parameters to the repeater 2104, at 2108. The configuration parameters sent by the donor gNB 2102 to the repeater 2104 may include resource allocation for SRS, access link receive beam configuration for SRS signals, and/or uplink allocation on the control link for forwarding SRS information (this can be a PUCCH allocation over the backhaul link). The repeater 2104 may receive the SRS signals from the UE 2106, at 2110. The repeater 2104 may process the SRS and may forward the SRS info such as for example L1 measurements to the donor gNB 2102 over PUCCH, at 2112. The repeater 2104 may also be configured to filter L1 measurements. For periodic and semi-persistent SRS signals, the repeater 2104 may be semi-statically configured for receiving the signals and the configuration parameter may also include the starting time and periodicity of SRS signals. The controller may acquire these configurations from the SIB and RRC messages transmitted by the gNB 2102.

As described above, FIG. 21 is provided as an example. Other examples are possible, according to some embodiments.

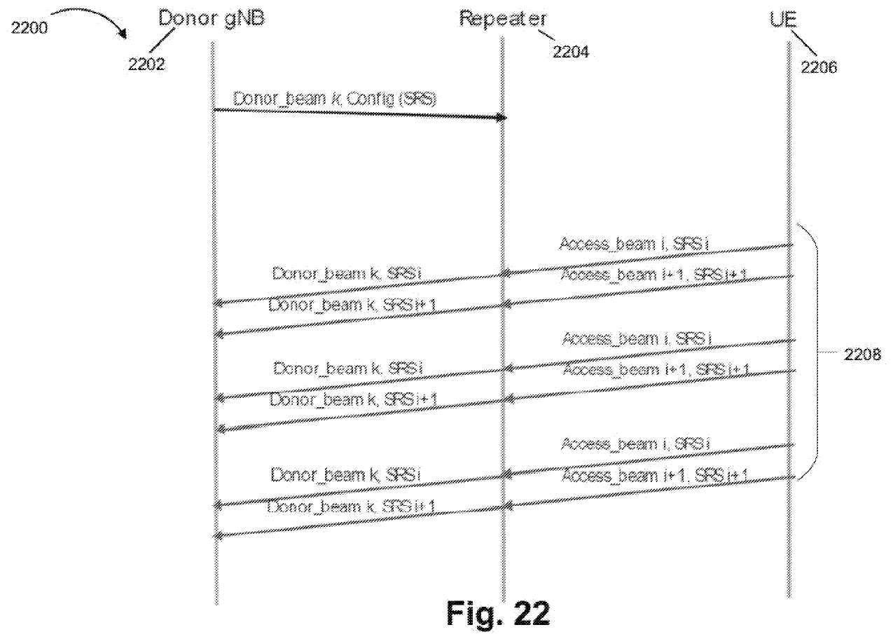

FIG. 22 illustrates an example signal diagram 2200 for SRS transmission by the hybrid beamforming repeater of FIG. 10, where the SRS is amplified and forwarded by the repeater, according to some embodiments. In an alternative to certain embodiments of FIG. 21, the repeater 2202 may amplify and forward the SRS signal over the backhaul link, at 2208. The donor gNB 2202 may allocate resources on the uplink and may receive SRS signals over its uplink receive beam for the BH link. The transmission of the SRS signal over both access and BH links may be used to acquire the MIMO channel state information for the entire radio link between the donor gNB 2202 and UE 2206 and may useful for FR1 deployments.

As described above, FIG. 22 is provided as an example. Other examples are possible, according to some embodiments.

In this way, certain embodiments described with respect to FIGS. 10-22 may provide various benefits (e.g., based on the hybrid repeater having its own cell resources). For example, a larger number of SSB beams than allowed in NR may enable wide area coverage by the repeater. Additionally, or alternatively, the generation of SSB signals and processing of PRACH by the repeater, independently of the gNB, may reduce the donor gNB's overhead. Additionally, or alternatively, the amplifying and forwarding scheme for PDSCH and PUSCH may provide latency reduction benefits for downlink and uplink traffic.

Additionally, or alternatively, the hybrid repeater may have a lower complexity compared to a full-function IAB node. For example, the hybrid repeater may not have to use RLC operations and/or BAP operations. Additionally, or alternatively, the repeater may not have to use full MAC operations of scheduling and multiplexing and/or de-multiplexing, and may just have to use partial MAC operations related to SSB/SIB, CSI-RS transmission, PRACH preamble detection and SRS processing. Since the hybrid repeater may not have to encode and decode the NR access link PDSCH and PUSCH channels, the LDPC encoder and/or decoder may not be needed. Furthermore, the repeater may have the option to use an off-the-shelf UE as the controller for the repeater. As a result, the lower complexity may reduce the cost of the hybrid repeater as well as development time.

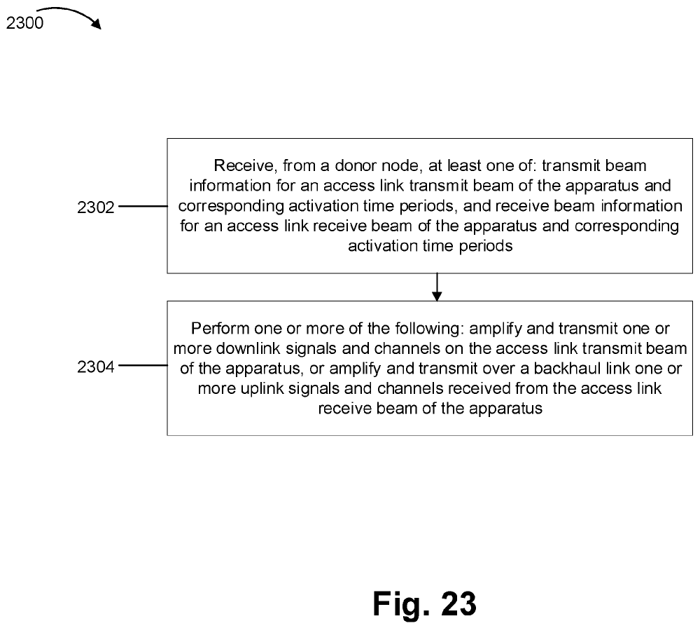

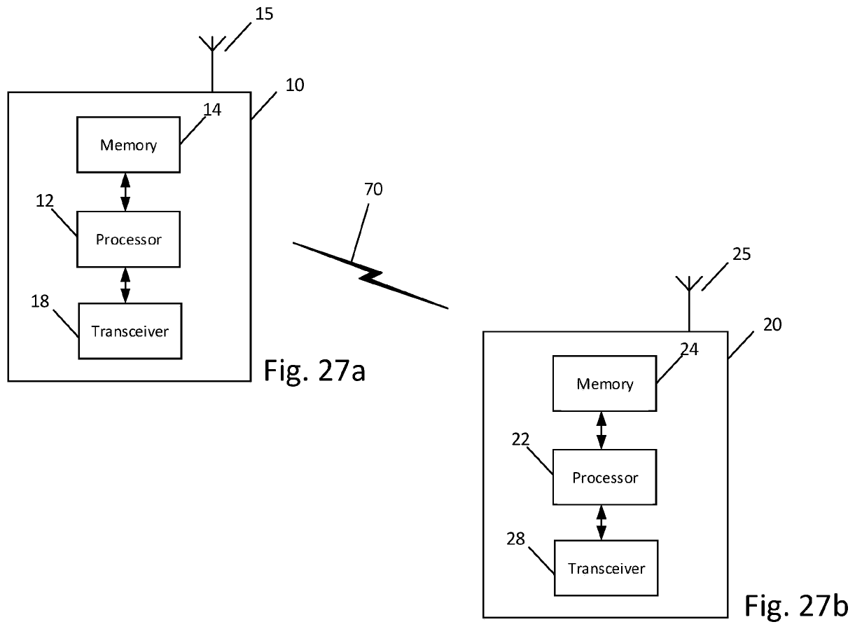

FIG. 23 illustrates an example flow diagram of a method 2300, according to some embodiments. For example, FIG. 23 may illustrate example operations of a network node (e.g., apparatus 10 illustrated in, and described with respect to, FIG. 27a). Specifically, FIG. 23 may illustrate example operations of the repeater of FIGS. 1-9. Some of the operations illustrated in FIG. 23 may be similar to some operations shown in, and described with respect to, FIGS. 1-9.

In an embodiment, the method 2300 may include, at 2302, receiving, from a donor node, at least one of: transmit beam information for an access link transmit beam of the apparatus and corresponding activation time periods, and receive beam information for an access link receive beam of the apparatus and corresponding activation time periods. There may be a mapping between transmission of downlink channel and signal over backhaul downlink beam and transmission over access link transmit beam, and between receiving over access link receive beam and receiving of uplink channel and signal over backhaul uplink beam (e.g., the activation period of the access link transmit beam may be synchronized with the transmission of the signals or channels by the donor over the backhaul link for downlink, and similarly for uplink). The method 2300 may include, at 2304, performing one or more of the following: amplifying and transmitting one or more downlink signals and channels on the access link transmit beam of the apparatus, or amplifying and transmitting over backhaul link one or more uplink signals and channels received from the access link receive beam of the apparatus.

The method illustrated in FIG. 23 may include one or more additional aspects described below or elsewhere herein. In some embodiments, the transmit beam information may include a semi-static transmit beam allocation, where the transmit beam information may be communicated as allocated SSBs and associated beams. Additionally, or alternatively, the transmit beam information may include a dynamic transmit beam allocation including the transmit beam and timing of PDCCH and/or PDSCH allocated by a donor network node (e.g., gNB). In some embodiments, the receive beam information may include a semi-static beam allocation where receive beam information is communicated as allocated PRACH opportunities and associated beams. Additionally, or alternatively, the receive beam information may include a dynamic receive beam allocation that includes the receive beam and timing of PUCCH and/or PUSCH allocated by the donor network node.

In some embodiments, when the signals to be transmitted comprise SSBs, the method 2300 may further include receiving a configuration that comprises scheduling of resources for the SSBs and a periodicity of the SSBs, e.g., in a manner similar to that at 308 of FIG. 3. In some embodiments, when the signals to be transmitted comprise SIB1, the method 2300 may further include receiving a configuration of scheduling information for SIB1, e.g., in a manner similar to that at 408 of FIG. 4. For example, SIB1 transmission may have a PDCCH transmission that includes the DCI followed by a PDSCH transmission containing the SIB1 content (as shown in FIG. 4). The SIB1 may be transmitted using the same set of beams as used for SSB (or may be a subset of SSB beams). The SIB1 configuration message may list the SSB indexes to identify the access link beams to use (the SSB index to access link beam mapping may have been performed during SSB configuration). In some embodiments, for an initial access procedure, the method 2300 may further including receiving a resource allocation and periodicity for each RACH occasion, and a receiver beam configuration for each RACH occasion, e.g., in a manner similar to that illustrated in, and described with respect to, FIG. 5. In some embodiments, for a random access procedure, the method 2300 may further include receiving configurations for Msg2 and Msg3 that include resource allocations and transmit beams for PDCCH for DCI and PDSCH for Msg2, and resource allocation and receive beam for PUSCH for Msg3, e.g., in a manner similar to that illustrated in, and described with respect to, FIG. 5. In some embodiments, for the random access procedure, the method 2300 may further include receiving a configuration for Msg4 that includes resource allocation and transmit beam for PDCCH for DCI and PDSCH for Msg4, and a resource allocation and receive beam for HARQ feedback, e.g., in a manner similar to that illustrated in, and described with respect to, FIG. 5.

In some embodiments, when the signals to be transmitted include downlink data, the method 2300 may further include receiving a configuration including resource allocations and access link transmit beams for PDCCH and PDSCH, and a resource allocation and access link receive beam for HARQ ACK/NACK, e.g., in a manner similar to that at 608 of FIG. 6. In some embodiments, when the signals to be received include uplink data, the method 2300 may further include receiving a configuration including a resource allocation and access link transmit beam for PDCCH and a resource allocation and access link receive beam for PUSCH, e.g., in a manner similar to that at 708 of FIG. 7. In some embodiments, when the signals to be transmitted include CSI-RS, the method 2300 may further include receiving a configuration including resource allocation for CSI-RS and an access link transmit beam configuration for CSI-RS signals, e.g., in a manner similar to that at 808 of FIG. 8. In some embodiments, when the signals to be received include SRSs, the method 2300 may further include receiving a configuration including resource allocations for the SRSs and an access link receive beam configuration for the SRS signals, e.g., in a manner similar to that at 908 of FIG. 9.

As described above, FIG. 23 is provided as an example. Other examples are possible according to some embodiments.

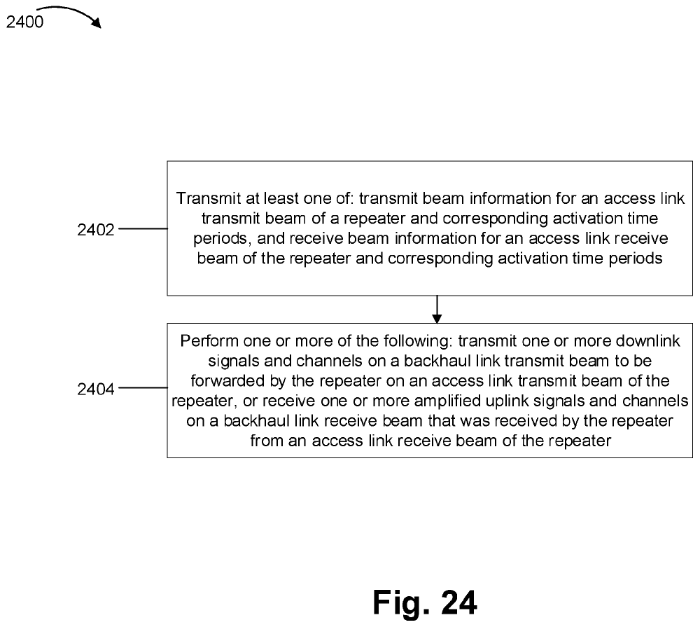

FIG. 24 illustrates an example flow diagram of a method 2400, according to some embodiments. For example, FIG. 24 may illustrate example operations of a network node (e.g., apparatus 10 illustrated in, and described with respect to, FIG. 27a). Specifically, FIG. 24 may illustrate example operations of the donor gNB of FIGS. 1-9. Some of the operations illustrated in FIG. 24 may be similar to some operations shown in, and described with respect to, FIGS. 1-9.

In an embodiment, the method may include, at 2402, transmitting at least one of: transmit beam information for an access link transmit beam of a repeater and corresponding activation time periods, and receive beam information for an access link receive beam of the repeater and corresponding activation time periods. There may be a mapping between transmission of downlink channel and signal over backhaul downlink beam and transmission over access link transmit beam, and between receiving over access link receive beam and receiving of uplink channel and signal over backhaul uplink beam (e.g., the activation period of the access link transmit beam may be synchronized with the transmission of the signals or channels by the donor over the backhaul link for downlink, and similarly for uplink). In some embodiments, the method 2400 may further include, at 2404, performing one or more of the following: transmitting one or more downlink signals and channels on backhaul link transmit beam to be forwarded by the repeater on an access link transmit beam of the repeater, or receiving one or more amplified uplink signals and channels on a backhaul link receive beam that was received by the repeater from an access link receive beam of the repeater.

The method illustrated in FIG. 24 may include one or more additional aspects described below or elsewhere herein. In some embodiments, the transmit beam information may include a semi-static transmit beam allocation, where the transmit beam information may be communicated as allocated SSBs and associated beams. Additionally, or alternatively, the transmit beam information may include a dynamic transmit beam allocation including the transmit beam and timing of PDCCH and/or PDSCH allocated by a donor network node (e.g., gNB). In some embodiments, the receive beam information may include a semi-static beam allocation where receive beam information is communicated as allocated PRACH opportunities and associated beams. Additionally, or alternatively, the receive beam information may include a dynamic receive beam allocation that includes the receive beam and timing of PUCCH and/or PUSCH allocated by the donor network node.

In some embodiments, when the signals to be transmitted by the repeater comprise SSBs, the method 2400 may further include transmitting a configuration that comprises scheduling of resources for the SSBs and a periodicity of the SSBs, e.g., in a manner similar to that at 308 of FIG. 3. In some embodiments, when the signals to be transmitted by the repeater comprise SIB1, the method 2400 may further include transmitting a configuration of scheduling information for SIB1, e.g., in a manner similar to that at 408 of FIG. 4. In some embodiments, for an initial access procedure, the method 2400 may further including transmitting a resource allocation and periodicity for each RACH occasion, and a receiver beam configuration for each RACH occasion, e.g., in a manner similar to that illustrated in, and described with respect to, FIG. 5. In some embodiments, for a random access procedure, the method 2400 may further include transmitting configurations for Msg2 and Msg3 that include resource allocations and transmit beams for PDCCH for DCI and PDSCH for Msg2, and resource allocation and receive beam for PUSCH for Msg3, e.g., in a manner similar to that illustrated in, and described with respect to, FIG. 5. In some embodiments, for the random access procedure, the method 2400 may further include transmitting a configuration for Msg4 that includes resource allocation and transmit beam for PDCCH for DCI and PDSCH for Msg4, and a resource allocation and receive beam for HARQ feedback, e.g., in a manner similar to that illustrated in, and described with respect to, FIG. 5.

In some embodiments, when the signals to be transmitted by the repeater include downlink data, the method 2400 may further include transmitting a configuration including resource allocations and access link transmit beams for PDCCH and PDSCH, and a resource allocation and access link receive beam for HARQ ACK/NACK, e.g., in a manner similar to that at 608 of FIG. 6. In some embodiments, when the signals to be received by the repeater include uplink data, the method 2400 may further include transmitting a configuration including a resource allocation and access link transmit beam for PDCCH and a resource allocation and access link receive beam for PUSCH, e.g., in a manner similar to that at 708 of FIG. 7. In some embodiments, when the signals to be transmitted by the repeater include CSI-RS, the method 2400 may further include transmitting a configuration including resource allocation for CSI-RS and an access link transmit beam configuration for CSI-RS signals, e.g., in a manner similar to that at 808 of FIG. 8. In some embodiments, when the signals to be received by the repeater include SRSs, the method 2400 may further include transmitting a configuration including resource allocations for the SRSs and an access link receive beam configuration for the SRS signals, e.g., in a manner similar to that at 908 of FIG. 9.

As described above, FIG. 24 is provided as an example. Other examples are possible according to some embodiments.

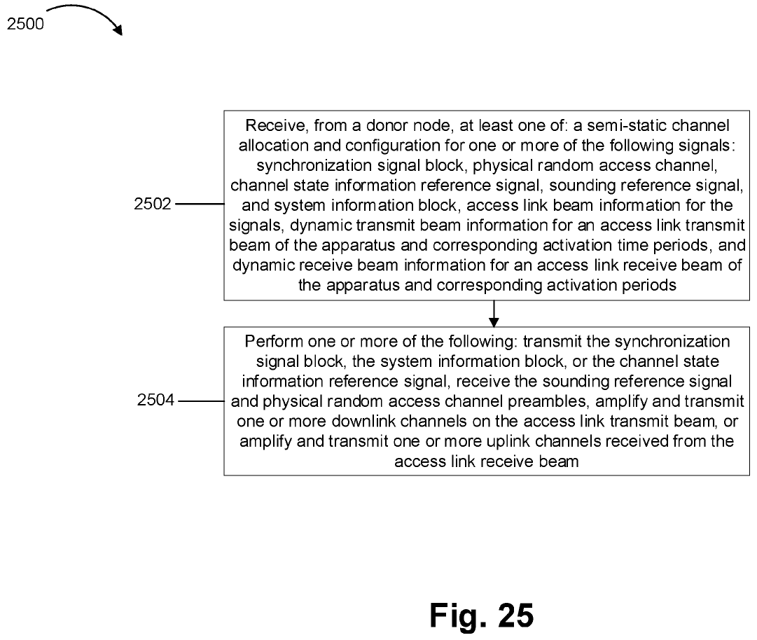

FIG. 25 illustrates an example flow diagram of a method 2500, according to some embodiments. For example, FIG. 25 may illustrate example operations of a network node (e.g., apparatus 10 illustrated in, and described with respect to, FIG. 27a). Specifically, FIG. 25 may illustrate example operations of the repeater of FIGS. 10-22. Some of the operations illustrated in FIG. 25 may be similar to some operations shown in, and described with respect to, FIGS. 10-22.

In an embodiment, the method 2500 may include, at 2502, receiving, from a donor node, at least one of: a semi-static channel allocation and configuration for one or more of the following signals: synchronization signal block, physical random access channel, channel state information reference signal, sounding reference signal, and system information block, access link beam information for the signals, dynamic transmit beam information for an access link transmit beam of the apparatus and corresponding activation time periods, and dynamic receive beam information for an access link receive beam of the apparatus and corresponding activation periods. The method 2500 may include, at 2504, performing one or more of the following: transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

The method illustrated in FIG. 25 may include one or more additional aspects described below or elsewhere herein. In some embodiments, when the signals to be transmitted comprise SSBs, the semi-static channel allocation and configuration may include scheduling of resources for the SSBs, a periodicity of the SSBs, an identifier for the apparatus, beams for SSBs, or MIB information, e.g., in a manner similar to that at 1408 of FIG. 14. In some embodiments, when the signals to be transmitted comprise SIB1s, the semi-static channel allocation and configuration may include scheduling information for SIB1, a periodicity for the SIB1s, or/and SIB1 content, e.g., in a manner similar to that at 1508 of FIG. 15. In some embodiments, for an initial access procedure, the semi-static channel allocation and configuration may include a resource allocation and periodicity for each RACH occasion, and a receiver beam configuration for each RACH occasion, e.g., in a manner similar to that illustrated in, and described with respect to, FIG. 16. In some embodiments, for the initial access procedure, the semi-static channel allocation and configuration may include, for Msg2, Msg3, and Msg4, resource allocations and transmit beams for PDCCH for DCI and PDSCH for Msg2, PUSCH for Msg3, and PDCCH for DCI and PDSCH for Msg4, e.g., in a manner similar to that illustrated in, and described with respect to, FIG. 16.

In some embodiments, when the data to be transmitted comprises downlink data, the dynamic channel allocation and configuration may include resource allocations and access link transmit beams for PDCCH and PDSCH, and resource allocation and access link receive beam for HARQ ACK/NACK, e.g., in a manner similar to that at 1708 of FIG. 17. In some embodiments, when the signals to be received include uplink data, the dynamic channel allocation and configuration may include resource allocations and access link transmit beams for PDCCH, and resource allocation and access link receive beam for PUSCH, e.g., in a manner similar to that at 1808 of FIG. 18. In some embodiments, when the signals to be transmitted include CSI-RSs, the semi-static channel allocation and configuration may include resource allocation for the CSI-RSs, and access link transmit beam configurations for CSI-RS signals, e.g., in a manner similar to that at 1908 of FIG. 19. In some embodiments, when the signals to be received include SRS signals, the semi-static channel allocation and configuration may include resource allocations for the SRSs and uplink allocation on the control link for forwarding the SRS information, e.g., in a manner similar to that at 2108 of FIG. 21.

As described above, FIG. 25 is provided as an example. Other examples are possible according to some embodiments.

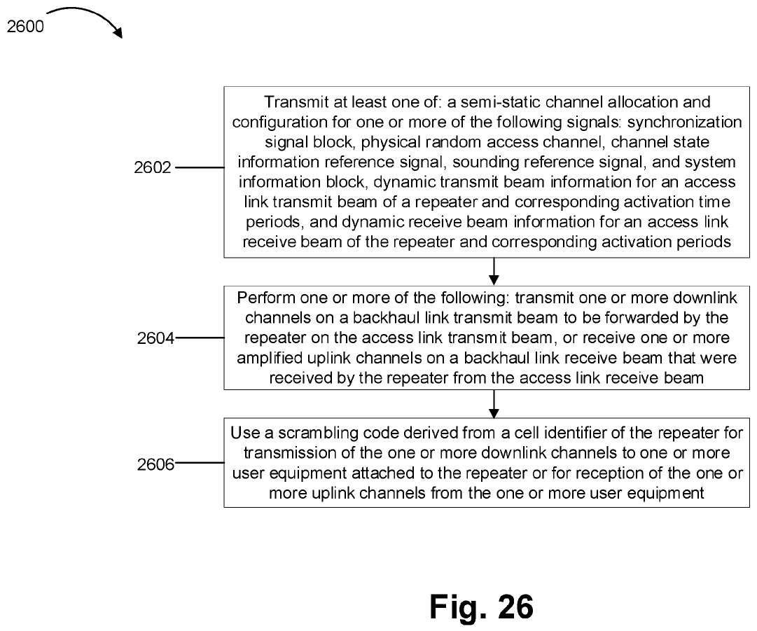

FIG. 26 illustrates an example flow diagram of a method 2600, according to some embodiments. For example, FIG. 26 may illustrate example operations of a network node (e.g., apparatus 10 illustrated in, and described with respect to, FIG. 27a). Specifically, FIG. 26 may illustrate example operations of the donor gNB of FIGS. 10-22. Some of the operations illustrated in FIG. 26 may be similar to some operations shown in, and described with respect to, FIGS. 10-22.

In an embodiment, the method 2600 may include, at 2602, transmitting at least one of: a semi-static channel allocation and configuration for one or more of the following signals: synchronization signal block, physical random access channel, channel state information reference signal, sounding reference signal, and system information block, dynamic transmit beam information for an access link transmit beam of a repeater and corresponding activation time periods, and dynamic receive beam information for an access link receive beam of the repeater and corresponding activation periods. The method 2600 may include, at 2604, performing one or more of the following: transmitting one or more downlink channels on a backhaul link transmit beam to be forwarded by the repeater on the access link transmit beam, or receiving one or more amplified uplink channels on a backhaul link receive beam that was received by the repeater from the access link receive beam. The method 2600 may include, at 2606, using a scrambling code derived from a cell identifier of the repeater for transmission of the one or more downlink channels to one or more user equipment attached to the repeater or for reception of the one or more uplink channels from the one or more user equipment.

The method illustrated in FIG. 26 may include one or more additional aspects described below or elsewhere herein. In some embodiments, when the signals to be transmitted by the repeater comprise SSBs, the semi-static channel allocation and configuration may include scheduling of resources for the SSBs, a periodicity of the SSBs, an identifier for the apparatus, or MIB information, e.g., in a manner similar to that at 1408 of FIG. 14. In some embodiments, when the signals to be transmitted by the repeater comprise SIB1s, the semi-static channel allocation and configuration may include scheduling information for SIB1, a periodicity for the SIB1s, or/and SIB1 content, e.g., in a manner similar to that at 1508 of FIG. 15. In some embodiments, for an initial access procedure, the semi-static channel allocation and configuration may include a resource allocation and periodicity for each RACH occasion, and a receiver beam configuration for each RACH occasion, e.g., in a manner similar to that illustrated in, and described with respect to, FIG. 16. In some embodiments, for the initial access procedure, the dynamic channel allocation and configuration may include, for Msg2, Msg3, and Msg4, resource allocations and transmit beams for PDCCH for DCI and PDSCH for Msg2, PUSCH for Msg3, and PDCCH for DCI and PDSCH for Msg4, e.g., in a manner similar to that illustrated in, and described with respect to, FIG. 16.

In some embodiments, when the data to be transmitted by the repeater comprises downlink data, the dynamic channel allocation and configuration may include resource allocations and access link transmit beams for PDCCH and PDSCH, and resource allocation and access link receive beam for HARQ ACK/NACK, e.g., in a manner similar to that at 1708 of FIG. 17. In some embodiments, when the signals to be received by the repeater include uplink data, the dynamic channel allocation and configuration may include resource allocations and access link transmit beams for PDCCH, and resource allocation and access link receive beam for PUSCH, e.g., in a manner similar to that at 1808 of FIG. 18. In some embodiments, when the signals to be transmitted by the repeater include CSI-RSs, the semi-static channel allocation and configuration may include resource allocation for the CSI-RSs, and access link transmit beam configurations for CSI-RS signals, e.g., in a manner similar to that at 1908 of FIG. 19. In some embodiments, when the signals to be received by the repeater include SRS signals, the semi-static channel allocation and configuration may include resource allocations for the SRSs and uplink allocation on the control link for forwarding the SRS information, e.g., in a manner similar to that at 2108 of FIG. 21.

As described above, FIG. 26 is provided as an example. Other examples are possible according to some embodiments.

FIG. 27a illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G. In some embodiments, apparatus 10 may be a repeater, controller, etc. described herein.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 27a.

As illustrated in the example of FIG. 27a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 27a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like.

According to certain embodiments, apparatus 10 may be controlled by memory 14 and processor 12 to perform the functions associated with any of the embodiments described herein, such as some operations illustrated in, or described with respect to, FIGS. 1-26. For instance, apparatus 10 may be controlled by memory 14 and processor 12 to perform the methods of FIGS. 23-26.

FIG. 27b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 27b.

As illustrated in the example of FIG. 27b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 27b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with any of the embodiments described herein, such as some operations illustrated in, or described with respect to, FIGS. 1-22.

In some embodiments, an apparatus (e.g., apparatus 10 and/or apparatus 20) may include means for performing a method or any of the variants discussed herein, e.g., a method described with reference to FIGS. 23-26. Examples of the means may include one or more processors, memory, and/or computer program code for causing the performance of the operation.

Therefore, certain example embodiments provide several technological improvements, enhancements, and/or advantages over existing technological processes. For example, one benefit of some example embodiments is reduced technical complexity of a repeater. Accordingly, the use of some example embodiments results in improved functioning of communications networks and their nodes and, therefore constitute an improvement at least to the technological field of repeater implementation, among others.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural wording is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

According to a first embodiment, a method may include receiving, from a donor node, at least one of: transmit beam information for an access link transmit beam of the apparatus and corresponding activation time periods, and receive beam information for an access link receive beam of the apparatus and corresponding activation time periods. There may be a mapping between transmission of downlink channel and signal over backhaul downlink beam and transmission over access link transmit beam, and between receiving over access link receive beam and receiving of uplink channel and signal over backhaul uplink beam (e.g., the activation period of the access link transmit beam may be synchronized with the transmission of the signals or channels by the donor over the backhaul link for downlink, and similarly for uplink). The method may include performing one or more of the following: amplifying and transmitting one or more downlink signals and channels on the access link transmit beam of the apparatus, or amplifying and transmitting over backhaul link one or more uplink signals and channels received from the access link receive beam of the apparatus.

In a variant, the transmit beam information may include a semi-static transmit beam allocation, where the transmit beam information may be communicated as allocated SSBs and associated beams. Additionally, or alternatively, the transmit beam information may include a dynamic transmit beam allocation including the transmit beam and timing of PDCCH and/or PDSCH allocated by a donor network node (e.g., gNB). In a variant, the receive beam information may include a semi-static beam allocation where receive beam information is communicated as allocated PRACH opportunities and associated beams. Additionally, or alternatively, the receive beam information may include a dynamic receive beam allocation that includes the receive beam and timing of PUCCH and/or PUSCH allocated by the donor network node.

In a variant, when the signals to be transmitted comprise SSBs, the method may further include receiving a configuration that comprises scheduling of resources for the SSBs and a periodicity of the SSBs. In a variant, when the signals to be transmitted comprise SIB1, the method may further include receiving a configuration of scheduling information for SIB1. In a variant, for an initial access procedure, the method may further including receiving a resource allocation and periodicity for each RACH occasion, and a receiver beam configuration for each RACH occasion. In a variant, for a random access procedure, the method may further include receiving configurations for Msg2 and Msg3 that include resource allocations and transmit beams for PDCCH for DCI and PDSCH for Msg2, and resource allocation and receive beam for PUSCH for Msg3. In a variant, for the random access procedure, the method may further include receiving a configuration for Msg4 that includes resource allocation and transmit beam for PDCCH for DCI and PDSCH for Msg4, and a resource allocation and receive beam for HARQ feedback.

In a variant, when the signals to be transmitted include downlink data, the method may further include receiving a configuration including resource allocations and access link transmit beams for PDCCH and PDSCH, and a resource allocation and access link receive beam for HARQ ACK/NACK. In a variant, when the signals to be received include uplink data, the method may further include receiving a configuration including a resource allocation and access link transmit beam for PDCCH and a resource allocation and access link receive beam for PUSCH. In a variant, when the signals to be transmitted include CSI-RS, the method may further include receiving a configuration including resource allocation for CSI-RS and an access link transmit beam configuration for CSI-RS signals. In a variant, when the signals to be received include SRSs, the method may further include receiving a configuration including resource allocations for the SRSs and an access link receive beam configuration for the SRS signals.

According to a second embodiment, a method may include transmitting at least one of: transmit beam information for an access link transmit beam of a repeater and corresponding activation time periods, and receive beam information for an access link receive beam of the repeater and corresponding activation time periods. There may be a mapping between transmission of downlink channel and signal over backhaul downlink beam and transmission over access link transmit beam, and between receiving over access link receive beam and receiving of uplink channel and signal over backhaul uplink beam (e.g., the activation period of the access link transmit beam may be synchronized with the transmission of the signals or channels by the donor over the backhaul link for downlink, and similarly for uplink). In some embodiments, the method may further include performing one or more of the following: transmitting one or more downlink signals and channels on BH link transmit beam to be forwarded by the repeater on an access link transmit beam of the repeater, or receiving one or more amplified uplink signals and channels on BH link receive beam that was received by the repeater from an access link receive beam of the repeater.

In a variant, the transmit beam information may include a semi-static transmit beam allocation, where the transmit beam information may be communicated as allocated SSBs and associated beams. Additionally, or alternatively, the transmit beam information may include a dynamic transmit beam allocation including the transmit beam and timing of PDCCH and/or PDSCH allocated by a donor network node (e.g., gNB). In a variant, the receive beam information may include a semi-static beam allocation where receive beam information is communicated as allocated PRACH opportunities and associated beams. Additionally, or alternatively, the receive beam information may include a dynamic receive beam allocation that includes the receive beam and timing of PUCCH and/or PUSCH allocated by the donor network node.

In a variant, when the signals to be transmitted by the repeater comprise SSBs, the method may further include transmitting a configuration that comprises scheduling of resources for the SSBs and a periodicity of the SSBs. In a variant, when the signals to be transmitted by the repeater comprise SIB1, the method may further include transmitting a configuration of scheduling information for SIB1. In a variant, for an initial access procedure, the method may further including transmitting a resource allocation and periodicity for each RACH occasion, and a receiver beam configuration for each RACH occasion. In a variant, for a random access procedure, the method may further include transmitting configurations for Msg2 and Msg3 that include resource allocations and transmit beams for PDCCH for DCI and PDSCH for Msg2, and resource allocation and receive beam for PUSCH for Msg3. In a variant, for the random access procedure, the method may further include transmitting a configuration for Msg4 that includes resource allocation and transmit beam for PDCCH for DCI and PDSCH for Msg4, and a resource allocation and receive beam for HARQ feedback.

In a variant, when the signals to be transmitted by the repeater include downlink data, the method may further include transmitting a configuration including resource allocations and access link transmit beams for PDCCH and PDSCH, and a resource allocation and access link receive beam for HARQ ACK/NACK. In a variant, when the signals to be received by the repeater include uplink data, the method may further include transmitting a configuration including a resource allocation and access link transmit beam for PDCCH and a resource allocation and access link receive beam for PUSCH. In a variant, when the signals to be transmitted by the repeater include CSI-RS, the method may further include transmitting a configuration including resource allocation for CSI-RS and an access link transmit beam configuration for CSI-RS signals. In a variant, when the signals to be received by the repeater include SRSs, the method may further include transmitting a configuration including resource allocations for the SRSs and an access link receive beam configuration for the SRS signals.

According to a third embodiment, a method may include receiving, from a donor node, at least one of: a semi-static channel allocation and configuration for one or more of the following signals: synchronization signal block, physical random access channel, channel state information reference signal, sounding reference signal, and system information block, access link beam information from the signals, dynamic transmit beam information for an access link transmit beam of the apparatus and corresponding activation time periods, and dynamic receive beam information for an access link receive beam of the apparatus and corresponding activation periods. The method may include performing one or more of the following: transmitting the synchronization signal block, the system information block, or the channel state information reference signal, receiving the sounding reference signal and physical random access channel preambles, amplifying and transmitting one or more downlink channels on the access link transmit beam, or amplifying and transmitting one or more uplink channels received from the access link receive beam.

In a variant, when the signals to be transmitted comprise SSBs, the semi-static channel allocation and configuration may include scheduling of resources for the SSBs, a periodicity of the SSBs, an identifier for the apparatus, beams for SSBs, or MIB information. In a variant, when the signals to be transmitted comprise SIB1s, the semi-static channel allocation and configuration may include scheduling information for SIB1, a periodicity for the SIB1s, or/and SIB1 content. In a variant, for an initial access procedure, the semi-static channel allocation and configuration may include a resource allocation and periodicity for each RACH occasion, and a receiver beam configuration for each RACH occasion. In a variant, for the initial access procedure, the semi-static channel allocation and configuration may include, for Msg2, Msg3, and Msg4, resource allocations and transmit beams for PDCCH for DCI and PDSCH for Msg2, PUSCH for Msg3, and PDCCH for DCI and PDSCH for Msg4.

In a variant, when the data to be transmitted comprises downlink data, the dynamic channel allocation and configuration may include resource allocations and access link transmit beams for PDCCH and PDSCH, and resource allocation and access link receive beam for HARQ ACK/NACK. In a variant, when the signals to be received include uplink data, the dynamic channel allocation and configuration may include resource allocations and access link transmit beams for PDCCH, and resource allocation and access link receive beam for PUSCH. In a variant, when the signals to be transmitted include CSI-RSs, the semi-static channel allocation and configuration may include resource allocation for the CSI-RSs, and access link transmit beam configurations for CSI-RS signals. In a variant, when the signals to be received include SRS signals, the semi-static channel allocation and configuration may include resource allocations for the SRSs and uplink allocation on the control link for forwarding the SRS information.

According to a fourth embodiment, a method may include transmitting at least one of: a semi-static channel allocation and configuration for one or more of the following signals: synchronization signal block, physical random access channel, channel state information reference signal, sounding reference signal, and system information block, dynamic transmit beam information for an access link transmit beam of a repeater and corresponding activation time periods, and dynamic receive beam information for an access link receive beam of the repeater and corresponding activation periods. The method may include performing one or more of the following: transmitting one or more downlink channels on BH link transmit beam to be forwarded by the repeater on the access link transmit beam, or receive one or more amplified uplink channels on BH link receive beam that was received by the repeater from the access link receive beam. The method may include using a scrambling code derived from a cell identifier of the repeater for transmission of the one or more downlink channels to one or more user equipment attached to the repeater or for reception of the one or more uplink channels from the one or more user equipment.

In a variant, when the signals to be transmitted by the repeater comprise SSBs, the semi-static channel allocation and configuration may include scheduling of resources for the SSBs, a periodicity of the SSBs, an identifier for the apparatus, or MIB information. In a variant, when the signals to be transmitted by the repeater comprise SIB1s, the semi-static channel allocation and configuration may include scheduling information for SIB1, a periodicity for the SIB1, or/and SIB1 content. In a variant, for an initial access procedure, the semi-static channel allocation and configuration may include a resource allocation and periodicity for each RACH occasion, and a receiver beam configuration for each RACH occasion. In a variant, for the initial access procedure, the dynamic channel allocation and configuration may include, for Msg2, Msg3, and Msg4, resource allocations and transmit beams for PDCCH for DCI and PDSCH for Msg2, PUSCH for Msg3, and PDCCH for DCI and PDSCH for Msg4.

In a variant, when the data to be transmitted by the repeater comprises downlink data, the dynamic channel allocation and configuration may include resource allocations and access link transmit beams for PDCCH and PDSCH, and resource allocation and access link receive beam for HARQ ACK/NACK. In a variant, when the signals to be received by the repeater include uplink data, the dynamic channel allocation and configuration may include resource allocations and access link transmit beams for PDCCH, and resource allocation and access link receive beam for PUSCH. In a variant, when the signals to be transmitted by the repeater include CSI-RSs, the semi-static channel allocation and configuration may include resource allocation for the CSI-RSs, and access link transmit beam configurations for CSI-RS signals. In a variant, when the signals to be received by the repeater include SRS signals, the semi-static channel allocation and configuration may include resource allocations for the SRSs and uplink allocation on the control link for forwarding the SRS information.

A fifth embodiment may be directed to an apparatus including at least one processor and at least one memory comprising computer program code. The at least one memory and computer program code may be configured, with the at least one processor, to cause the apparatus at least to perform the method according to the first embodiment, the second embodiment, the third embodiment, or the fourth embodiment, or any of the variants discussed above.

A sixth embodiment may be directed to an apparatus that may include circuitry configured to cause the apparatus to perform the method according to the first embodiment, the second embodiment, the third embodiment, or the fourth embodiment, or any of the variants discussed above.

A seventh embodiment may be directed to an apparatus that may include means for performing the method according to the first embodiment, the second embodiment, the third embodiment, or the fourth embodiment, or any of the variants discussed above. Examples of the means may include one or more processors, memory, and/or computer program codes for causing the performance of the operation.

An eighth embodiment may be directed to a computer readable medium comprising program instructions stored thereon for causing an apparatus to perform at least the method according to the first embodiment, the second embodiment, the third embodiment, or the fourth embodiment, or any of the variants discussed above.

A ninth embodiment may be directed to a computer program product encoding instructions for causing an apparatus to perform at least the method according to the first embodiment, the second embodiment, the third embodiment, or the fourth embodiment, or any of the variants discussed above.

PARTIAL GLOSSARY

| | |
|---|---|
| 3GPP | 3rd Generation Partnership Project |
| BH | Backhaul |
| BAP | Backhaul Access Protocol |
| CSI-RS | Channel State Information Reference Signal |
| DCI | Downlink Control Information |
| DL-SCH | Downlink Shared Channel |
| IAB-MT | Integrated Access and Backhaul-Mobile Terminal |
| MAC | Medium Access Control |
| NR | 3GPP New Radio |
| PDCCH | Physical Downlink Control Channel |
| PDSCH | Physical Downlink Data Channel |
| PHY | Physical layer |
| PRACH | Physical Random Access Channel |
| PUCCH | Physical Uplink Control Channel |
| PUSCH | Physical Uplink Data Channel |
| RACH | Random Access Channel |
| RAT | Radio Access Technology |
| RLC | Radio Link Control |
| Rx | Receiver |
| SIB | System Information Block |
| SIB 1 | System Information Block1 |
| SRS | Sounding Reference Signal |
| SSB | Synchronization Signal Block |
| TDD | Time Division Duplexing |
| Tx | Transmitter |
| UE | User Equipment |
| UL-SCH | Uplink Shared Channel |

1-140. (canceled)

141. An apparatus, comprising:
at least one processor; and
at least one memory storing instructions that, when executed by the at least one processor, cause the apparatus at least to:
receive, from a donor network node, at least one of transmit beam information for an access link transmit beam of a network element and corresponding activation time periods, and
receive beam information for an access link receive beam of the network element and corresponding activation time periods,
wherein there is a mapping between transmission of a downlink channel and signal over backhaul downlink beam and transmission over the access link transmit beam, and between receiving over the access link receive beam and receiving of an uplink channel and signal over backhaul uplink beam; and
perform one or more of amplifying and transmitting one or more downlink signals and channels on the access link transmit beam of the network element, or amplifying and transmitting over a backhaul link one or more uplink signals and channels received from the access link receive beam of the network element.

142. The apparatus according to claim 141,
wherein the transmit beam information comprises at least one of a semi-static transmit beam allocation wherein the transmit beam information is communicated as allocated synchronization signal blocks and associated beams, or a dynamic transmit beam allocation comprising a transmit beam and timing of a physical downlink control channel or a physical downlink shared channel allocated by the donor network node.

143. The apparatus according to claim 141, wherein the receive beam information comprises at least one of a semi-static beam allocation where receive beam information is communicated as allocated physical random access channel opportunities and associated beams, or a dynamic receive beam allocation that comprises a receive beam and timing of a physical uplink control channel or a physical uplink shared channel allocated by the donor network node.

144. The apparatus according to claim 141, wherein the instructions, when executed by the at least one processor, cause the apparatus at least to perform at least one of:
when the signals to be transmitted comprise synchronization signal blocks, receiving a configuration that comprises scheduling of resources for the synchronization signal blocks and a periodicity of the synchronization signal blocks;
when the signals to be transmitted comprise system information block, receiving a configuration of scheduling information for the system information block;
for an initial access procedure, receiving a resource allocation and periodicity for a random access channel occasion, and a receiver beam configuration for the random access channel occasion;
for a random access procedure, receiving configurations for a first message and a second message that comprise a resource allocation and a transmit beam for a physical downlink control channel for downlink control information and a physical downlink shared channel for the first message, and a resource allocation and a receive beam for physical uplink shared channel for the second message;
when the signals to be transmitted comprise downlink data, receiving a configuration comprising a resource allocation and an access link transmit beams for a physical downlink control channel and a physical downlink shared channel, and a resource allocation and an access link receive beam for hybrid automatic repeat request acknowledgement/non-acknowledgement;
when the signals to be received comprise uplink data, receiving a configuration comprising a resource allocation and an access link transmit beam for a physical downlink control channel and a resource allocation and an access link receive beam for a physical uplink shared channel;
when the signals to be transmitted comprise a channel state information reference signal, receiving a configuration comprising a resource allocation for the channel state information reference signal and an access link transmit beam configuration for the channel state information reference signal; or
when the signals to be received comprise sounding reference signals, receiving a configuration comprising a resource allocation for the sounding reference signals and an access link receive beam configuration for the sounding reference signals.

145. The apparatus according to claim 141, wherein the instructions, when executed by the at least one processor, cause the apparatus at least to, for a random access procedure, receive a configuration for a third message that comprises a resource allocation and a transmit beam for a physical downlink control channel for downlink control information and a physical downlink shared channel for the third message, and a resource allocation and a receive beam for hybrid automatic repeat request feedback.

146. An apparatus, comprising:
at least one processor; and
at least one memory storing instructions that, when executed by the at least one processor, cause the apparatus at least to:
transmit at least one of
transmit beam information for an access link transmit beam of a repeater and corresponding activation time periods, and
receive beam information for an access link receive beam of the repeater and corresponding activation time periods,
wherein there is a mapping between transmission of a downlink channel and signal over backhaul downlink beam and transmission over the access link transmit beam, and between receiving over the access link receive beam and receiving of an uplink channel and signal over backhaul uplink beam; and
perform one or more of
transmitting one or more downlink signals and channels on a backhaul link transmit beam to be forwarded by the repeater on an access link transmit beam of the repeater, or receiving one or more amplified uplink signals and channels on a backhaul link receive beam that was received by the repeater from an access link receive beam of the repeater.

147. The apparatus according to claim 146,
wherein the transmit beam information comprises at least one of a semi-static transmit beam allocation wherein the transmit beam information is communicated as allocated synchronization signal blocks and associated beams, or a dynamic transmit beam allocation comprising a transmit beam and timing of a physical downlink control channel or a physical downlink shared channel allocated by a donor network node.

148. The apparatus according to claim 146, wherein the receive beam information comprises at least one of a semi-static beam allocation where receive beam information is communicated as allocated physical random access channel opportunities and associated beams, or a dynamic receive beam allocation that comprises a receive beam and timing of a physical uplink control channel or a physical uplink shared channel allocated by the donor network node.

149. The apparatus according to claim 146, wherein the instructions, when executed by the at least one processor, cause the apparatus at least to perform at least one of:
when the signals to be transmitted by the repeater comprise synchronization signal blocks, transmitting a configuration that comprises scheduling of resources for the synchronization signal blocks and a periodicity of the synchronization signal blocks;
when the signals to be transmitted by the repeater comprise a system information block, transmitting a configuration of scheduling information for the system information block;
for an initial access procedure, transmitting a resource allocation and periodicity for a random access channel occasion, and a receiver beam configuration for the random access channel occasion;
for a random access procedure, transmitting configurations for a first message and a second message that comprise a resource allocation and a transmit beam for a physical downlink control channel for downlink control information and a physical downlink shared channel for the first message, and a resource allocation and a receive beam for a physical uplink shared channel for the second message;
when the signals to be transmitted by the repeater comprising downlink data, transmitting a configuration comprising a resource allocation and an access link transmit beams for a physical downlink control channel and a physical downlink shared channel, and a resource allocation and an access link receive beam for hybrid automatic repeat request acknowledgement/non-acknowledgement;
when the signals to be received by the repeater comprises uplink data, transmitting a configuration comprising a resource allocation and an access link transmit beam for a physical downlink control channel and a resource allocation and an access link receive beam for a physical uplink shared channel;
when the signals to be transmitted by the repeater comprise a channel state information reference signal, transmitting a configuration comprising resource allocation for the channel state information reference signal and an access link transmit beam configuration for the channel state information reference signal; or
when the signals to be received by the repeater comprises sounding reference signals, transmitting a configuration comprising a resource allocation for the sounding reference signals and an access link receive beam configuration for the sounding reference signals.

150. The apparatus according to claim 146, wherein the instructions, when executed by the at least one processor, cause the apparatus at least to, for a random access procedure, transmit a configuration for a third message that comprises a resource allocation and a transmit beam for a physical downlink control channel for downlink control information and a physical downlink shared channel for the third message, and a resource allocation and a receive beam for hybrid automatic repeat request feedback.

151. A method, comprising:
receiving, from a donor network node, at least one of transmit beam information for an access link transmit beam of a network element and corresponding activation time periods, and
receive beam information for an access link receive beam of the network element and corresponding activation time periods,
wherein there is a mapping between transmission of a downlink channel and signal over backhaul downlink beam and transmission over the access link transmit beam, and between receiving over the access link receive beam and receiving of an uplink channel and signal over backhaul uplink beam; and
performing one or more of amplifying and transmitting one or more downlink signals and channels on the access link transmit beam of the network element, or amplifying and transmitting over a backhaul link one or more uplink signals and channels received from the access link receive beam of the network element.

152. The method according to claim 151,
wherein the transmit beam information comprises at least one of a semi-static transmit beam allocation where the transmit beam information is communicated as allocated synchronization signal blocks and associated beams, or a dynamic transmit beam allocation comprising a transmit beam and timing of a physical downlink control channel or a physical downlink shared channel allocated by the donor network node.

153. The method according to claim 151, wherein the receive beam information comprises at least one of a semi-static beam allocation where receive beam information is communicated as allocated physical random access channel opportunities and associated beams, or a dynamic receive beam allocation that comprises a receive beam and timing of a physical uplink control channel or a physical uplink shared channel allocated by the donor network node.

154. The method according to claim 151, further comprises at least one of:
when the signals to be transmitted comprise synchronization signal blocks, receiving a configuration that comprises scheduling of resources for the synchronization signal blocks and a periodicity of the synchronization signal blocks;
when the signals to be transmitted comprise system information block, receiving a configuration of scheduling information for the system information block;
for an initial access procedure, receiving a resource allocation and periodicity for a random access channel occasion, and a receiver beam configuration for the random access channel occasion;
for a random access procedure, receiving configurations for a first message and a second message that comprise a resource allocation and a transmit beam for a physical downlink control channel for downlink control information and a physical downlink shared channel for the first message, and a resource allocation and a receive beam for physical uplink shared channel for the second message;
when the signals to be transmitted comprise downlink data, receiving a configuration comprising a resource allocation and an access link transmit beam for a physical downlink control channel and a physical downlink shared channel, and a resource allocation and an access link receive beam for hybrid automatic repeat request acknowledgement/non-acknowledgement;
when the signals to be received comprise uplink data, receiving a configuration comprising a resource allocation and an access link transmit beam for a physical downlink control channel and a resource allocation and an access link receive beam for a physical uplink shared channel;
when the signals to be transmitted comprise a channel state information reference signal, receiving a configuration comprising a resource allocation for the channel state information reference signal and an access link transmit beam configuration for the channel state information reference signal; or
when the signals to be received comprise sounding reference signals, receiving a configuration comprising a resource allocation for the sounding reference signals and an access link receive beam configuration for the sounding reference signals.

155. The method according to claim 151, further comprises, for a random access procedure, receiving a configuration for a third message that comprises a resource allocation and a transmit beam for a physical downlink control channel for downlink control information and a physical downlink shared channel for the third message, and a resource allocation and a receive beam for hybrid automatic repeat request feedback.
